(19) United States
(12) Patent Application Publication
(10) Pub. No.: US 2023/0017153 A1
(43) Pub. Date: Jan. 19, 2023

(54) TEMPERATURE CONTROLLED BIPOLAR BATTERY ASSEMBLY

(71) Applicant: ADVANCED BATTERY CONCEPTS, LLC, Clare, MI (US)

(72) Inventors: Edward O. Shaffer, II, Farwell, MI (US); Shaun Bruno, Corunna, MI (US); Michael Everett, Clare, MI (US); Brian R. Sturdavant, Clare, MI (US); Keith Foley, Farwell, MI (US); Adam V. Cadena, Auburn, MI (US); Cody Chartier, Midland, MI (US); Xin Shen, Clare, MI (US); Jake Tilmann, Farwell, MI (US); Jeffrey L. Adkins, Clare, MI (US)

(21) Appl. No.: 17/787,345

(22) PCT Filed: Dec. 18, 2020
(86) PCT No.: PCT/US2020/065842

§ 371 Date: Jun. 20, 2022

Related U.S. Application Data
(60) Provisional application No. 62/950,201, filed on Dec. 19, 2019.

(51) Int. Cl. H01M 10/6568; H01M 10/613; H01M 10/6554; H01M 10/0585

(52) U.S. Cl. CPC H01M 10/6568; H01M 10/613; H01M 10/6554; H01M 10/0585; H01M 2004/029

(57) ABSTRACT

A bipolar battery assembly having: a) a plurality of electrode plates stacked together to form an electrode plate stack; b) a liquid electrolyte located between each pair of the electrode plates; and c) one or more channels passing transversely through the plurality of electrode plates and the liquid electrolyte; and wherein the one or more channels include one or more seals therein to seal the one or more channels from the liquid electrolyte.

### FIELD

The present disclosure relates generally to a bipolar battery assembly and specifically to one or more channels within the battery assembly. The present disclosure may find particular use in temperature control of a bipolar battery from within an interior during pickling, formation, charging, discharging, or even during operation.

### BACKGROUND

Traditionally, bipolar battery assemblies, such as that taught in US Publication No. US 2009/0042099, incorporated herein by reference, include an electrolyte within a stack of electrode plates. The electrolyte allows electrons and ions to flow between the cathode and anode material of the electrode plates. The bipolar battery assemblies are held together by bolts which pass through aligned through-holes in the electrode plates and separators. To provide an electrolyte which does not leak from the electrode stack or into channels of the stack, a solid electrolyte is generally used to reduce the need for separate sealing members within the battery assembly.

A challenge presented by typical bipolar battery assemblies is that the battery may produce excess heat when pickling, during formation, or while charging or discharging. Excess heat may occur because of power dissipation as current flows through the internal resistance of the battery during charging or discharging (also known as Joule heating). Excess heat may also occur from exothermic reactions within the electrochemical cells during charging or discharging. Excessive heat generated in a battery assembly can result in a number of issues, including: active chemicals may expand causing the electrochemical cells to swell, pressure may build up inside the electrochemical cells, increased swelling and pressure may cause mechanical distortion of components (such as outward deformation, e.g., bulging), mechanical distortion may result in short circuiting as components move away from one another and create leak paths or contact is lost, cracking of components may occur due to prolonged operation at excessively high temperatures, thermal runaway may occur during chemical reactions, gasses may be given off, and/or one or more cells may rupture or explode due to the increased temperatures. Due to these potential issues, the rate at which a battery assembly may be able to be charged or discharged is thus dependent on the rate at which excess generated heat is able to be removed. Another challenge presented by bipolar battery assemblies is their ability to be charged at cold or hot temperatures. In low temperatures (such as below 5° C.), some batteries may build up pressure within cells leading to venting. Poor charge acceptance in cold temperatures may mimic a fully charged battery due to the pressure build up.

Today there are a number of different processes utilized for controlling the temperature of a battery during charging and discharging. Some batteries may include thermal blankets which heat the batteries to acceptable temperatures for charging. A battery assembly may be submerged within a temperature-controlled water bath. To control the generation of excess heat, batteries may be charged or even discharged at a slower, controlled rate which keeps the battery temperature beneath a threshold temperature. Each of these processes adds additional processing time to charging a battery assembly. Due to the lengthy processing time, multiple battery assemblies may be stored at a facility to rotate through charging while other battery assemblies are being used. These additional processes lead to additional costs in the inventory of battery assemblies, equipment for cooling and heating, storage space, electricity used for charging, and labor in changing the charged batteries with discharged batteries.

What is needed is a battery assembly which is able to be temperature controlled from within an interior. What is needed is a battery assembly which is able to have its temperature controlled to allow for faster charging. What is needed is a battery assembly which can be cooled or heated to allow for faster charging. What is needed is a battery assembly with one or more channels useful for cooling, heating, or both which are able to pass through one or more electrochemical cells while remaining sealed. What is needed is one or more channels which are sealed from a surrounding liquid electrolyte and seal in one or more fluids within the one or more channels.

### SUMMARY

The present disclosure relates to a bipolar battery assembly comprising: a) a plurality of electrode plates stacked together to form an electrode plate stack; b) a liquid electrolyte located between each pair of the electrode plates; and c) one or more channels passing transversely through the plurality of electrode plates and the liquid electrolyte; and wherein the one or more channels include one or more seals therein to seal from the one or more channels from the liquid electrolyte.

The present disclosure relates to a bipolar battery assembly comprising: a) a plurality of electrode plates stacked together to form an electrode plate stack; b) a liquid electrolyte located between each pair of the electrode plates; c) one or more channels passing transversely through the plurality of electrode plates and the liquid electrolyte, wherein the one or more channels include one or more seals therein to seal the one or more channels from the liquid electrolyte; and d) one or more fluids which circulate through the one or more channels; and wherein the one or more fluids are configured to add heat, remove heat, or both from the bipolar battery.

The bipolar battery assembly of the presenting teachings may include one or more of the following features in any combination: one or more channels may include one or more cooling channels configured to remove heat from an interior of the bipolar battery assembly; the one or more cooling channels include, may be in communication with, or both one or more heat exchangers. The one or more heat exchangers may include one or more active heat exchangers, passive heat exchangers, or both; the one or more heat exchangers may include one or more fluid heat exchangers, pipe heat exchangers, shell and tube heat exchangers, plate heat exchangers, heat sinks, phase-change heat exchangers, waste heat recovery units, thermoelectric devices (“TED”), or any combination thereof; the one or more channels may be formed by one or openings in each individual electrode plate of the plurality of electrode plates which are aligned with one another the bipolar battery assembly may include a plurality of separators with an individual separator located between each pair of electrode plates; the plurality of separators may each include one or more openings which are aligned with one or more openings of the electrode plates which form the one or more channels; one or more openings of the plurality of electrode plates, the plurality of separators, or both may each include one or more inserts located and/or formed therein; the one or more inserts may mate with one or more other inserts to form the one or more channels and seal the one or more channels from the liquid electrolyte; the one or more seals may be molded along one or more internal surfaces of the one or more channels to seal the one or more channels form the liquid electrolyte: the one or more seals include one or more thermoplastics; the one or more seals may be formed by one or more inward facing surfaces of one or more inserts aligned and interlocking to form the one or more channels (e.g., by the inward facing surfaces being melt-bonded), separate from and located on the one or more inward facing surfaces of the one or more inserts, or both; the seal of each of the one or more channels may increase a strength of the bipolar battery assembly in a transverse direction, wherein the transverse direction is the same as a longitudinal axis of the one or more channels; the one or more seals may run along an entire length of the one or more channels in which they are located; the one or more seals may include one or more tubular members which are located within the one or more channels; one or more tubular members may be molded in place within the one or more channels; one or more fluids may be located within the one or more channels; the one or more fluids may be circulated through the one or more channels; the one or more fluids may be configured to add heat, remove heat, or both from the bipolar battery assembly; the one or more channels may have the one or more fluids may be the one or more cooling channels; one or more rods may be located within the one or more channels; the one or more rods may be sealed; one or more rods may be molded in place within the one or more channels; one or more rods may form the one or more seals, may be located within the one or more seals, or both; the one or more rods may be one or more tubular members, may be located within one or more tubular members, or both; the one or more rods may have a thermo-conductivity of about 100 W/m·K or greater; the one or more rods may have a thermo-conductivity of about 200 W/m·K or greater; the one or more rods may comprise aluminum, copper, boron arsenide, diamond, graphene, carbon nanotubes, or a combination thereof; the one or more rods may comprise one or more heat pipes with one or more fluids sealed therein; the one or more rods may include one or more open ends such that one or more fluids may be able to flow in and out of the one or more rods; one or more heat sinks may be in communication, either direct or indirect, with the one or more rods; one or more heat sinks may be air-cooled, cooled by a circulating fluid, or both; one or more tubing couplers may be located on one or more ends of at least one of the one or more channels; one or more tubing couplers may be: insert-molded within the one or channels, molded directly within the one or more channels, one or more threaded fittings, one or more compression fittings, one or more friction fittings, or a combination thereof.

The present disclosure relates to a method of controlling a temperature of one or more battery assemblies by circulating one or more fluids through one or more channels according to the teachings herein.

The present disclosure a method of assembling and cooling the bipolar battery assembly of the present teachings, including circulating one or more fluids through one or more channels to remove heat from an interior of the bipolar battery assembly.

The methods of the present teachings may include one or more of the following features in any combination: circulating the one or more fluids may be via one or more flow mechanisms; one or more fluids prior to being circulated through the one or more channels may have a temperature differential with an interior temperature of the battery assembly of about 50° or greater; the interior temperature of the bipolar battery assembly may be prior to or simultaneous with the one or more fluids passing therethrough; the one or more fluids may have a temperature of about 0° C. or greater; the one or more fluids may be circulated through the one or more channels during pickling, formation, charging, discharging, or a combination thereof of the bipolar battery assembly; forming the electrode plate stack may include stacking the plurality of electrode plates to create a plurality of electrochemical cells therebetween; the method may include filling the plurality of electrochemical cells with a liquid electrolyte; and the method may include inserting and/or affixing one or more heat exchangers to the one or more channels.

The present teachings provide for a battery assembly having one or more channels passing transversely therethrough. The one or more channels may have one or more tubular members therein which act as heat exchangers. The one or more tubular members may function to heat, cool, or both the battery assembly from within an interior. By cooling or heating the battery assembly from within the interior, the temperature control may be faster than if cooled or heated from or only the exterior. One or more heat exchangers may be in communication with one or more channels. One or more heat exchangers on an exterior of the battery assembly may help transfer heat from within an interior (e.g., one or more channels) to the exterior of the battery assembly. The one or more channels may be sealed from surrounding liquid electrolyte by one or more inserts of one or more openings which are aligned and interlocks. The one or more tubular members may prevent one or more fluids passing therethrough from leaking out into the electrochemical cells of the battery assembly.

### BRIEF DESCRIPTION OF DRAWINGS

FIG. 1 is a front view of an end plate having an internal reinforcement structure.

FIG. 2 is a perspective view of a battery assembly having the endplate of FIG. 1 and a membrane disposed about the periphery.

FIG. 3 illustrates a partially exploded stack of electrode plates of a battery assembly.

FIG. 4 illustrates a partially exploded stack of electrode plates of a battery assembly.

FIG. 5 illustrates a cross-section along section A-A as shown in FIG. 1 of a battery assembly.

FIG. 6 illustrates a perspective view of a battery assembly.

FIG. 7A illustrates a perspective view of a battery assembly.

FIG. 7B illustrates a perspective view of a battery assembly.

FIG. 8 illustrates a perspective view of a cross-section through one or more channels of a battery assembly.

FIG. 9 illustrates a perspective view of a cross-section through one or more channels of a battery assembly.

FIG. 10 illustrates a graph comparing a battery assembly with and without cooling channels.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Bipolar Battery Assembly

The battery assembly of the disclosure generally relates to a battery assembly and may find particular use as a bipolar battery assembly (also referred to as “bipolar battery”). The battery assembly includes one or more stacks of a plurality of electrode plates. The plurality of electrode plates may include one or more bipolar plates, monopolar plates, dual polar plates, end plates, or any combination thereof. The one or more bipolar plates include a substrate having an anode one surface and a cathode on an opposing surface. A monopolar plate may include either an anode or a cathode deposited on a surface. First and second monopolar plates may be located at opposing ends of the one or more stacks having the bipolar plates, dual polar plates, or both located therebetween. The battery assembly may include one or more end plates, such as a first end plate and a second plate. The one or more end plates are attached at one or more ends of the stack. The one or more end plates may be the one or more monopolar plates or separate from the monopolar plates. For example, a first end plate may be attached at an opposing end of the stack as a second end plate. The one or more end plates may be particularly useful for reinforcing one or more electrode plates during drawing of a vacuum within the battery assembly, filling of the battery assembly, during operation in a charge and/or discharge cycle of the battery assembly, or any combination thereof. The stack includes a separator and an electrolyte located between each adjacent pair of the electrode plates. The electrolyte may cooperate with an anode and cathode to form an electrochemical cell. The battery assembly may include one or more channels. The one or more channels may pass transversely through one or more electrode plates, electrolyte, separators, or a combination thereof. The one or more channels may be formed by openings, inserts, or both. The one or more openings, inserts, or both may be part of (e.g., attached, integral) the one or more electrode plates, separators, or both. The one or more channels may be sealed from a liquid electrolyte through which the one or more channels pass through. One or more fluids may circulate through the one or more channels. The one or more fluids may aid in controlling temperature of the battery assembly during pickling, forming, charging, discharging or any combination thereof.

The battery assembly may include one or more end plates. The one or more end plates may function to reinforce one or more electrode plates, resist, or prevent both outward and inward deformation of one or more electrode plates due to pressure differentials within a battery assembly compared to the external environment, prevent semi-permanent or permanent damage to one or more electrode plates, ensure interlocked components which create a seal remain sealed, or any combination thereof. The one or more end plates may have any size, shape, and/or configuration to reinforce one or more electrode plates, resist or prevent both outward and inward deformation of one or more electrode plates due to pressure differentials within a battery assembly compared to the external environment, prevent semi-permanent or permanent damage to one or more electrode plates, ensure interlocked components which create a seal remain sealed, or any combination thereof. The one or more end plates may or may not be an electrode plate. One or more end plates may be one or more monopolar plates. For example, at opposing ends of the stack of electrode plates, each monopolar plate may be an end plate. The one or more end plates may be adjacent to one or more electrode plates. For example, at opposing ends of the stack of electrode plates which include opposing monopolar plates, an end plate may be affixed to each monopolar plate. The one or more end plates may be attached to one or more electrode plates at opposing ends of a stack. For example, a stack may include a first end plate at an opposing end of the stack as a second end plate. The one or more end plates may be sufficiently rigid to resist outward bulging created by temperatures and pressures within a battery assembly during operation, resist inward bending during pulling of a vacuum inside of the battery assembly, or both. The end plate may include a base, an internal reinforcement structure, one or more openings, one or more raised inserts, one or more attachment mechanisms, or any combination thereof. Exemplary end plates with an internal reinforcement structure, inserts, openings, and useful as a monopolar plate are discussed in U.S. Pat. No. 10,141,598 incorporated herein by reference.

The battery assembly may include a plurality of electrode plates. The electrode plates may be useful in use as bipolar plates, monopolar plates, dual polar plates, end plates, the like, or any combination thereof. The plurality of electrode plates are stacked together to form an electrode plate stack (also referred to herein as “stack” and “stack of electrode plates”). An electrode plate may function as one or more electrodes, include one or more electroactive materials, be part of an electrochemical cell, form part of one or more sealing structures, or any combination thereof. A plurality of electrode plates may function to conduct an electric current (i.e., flow of ions and electrons) within the battery assembly. A plurality of electrode plates may form one or more electrochemical cells. For example, a pair of electrode plates, which may have a separator and/or electrolyte therebetween, may form an electrochemical cell. The number of electrode plates present can be chosen to provide the desired voltage of the battery. The battery assembly design provides flexibility in the voltage that can be produced. The plurality of electrode plates can have any desired cross-sectional shape and the cross-sectional shape can be designed to fit the packaging space available in the use environment. Cross-sectional shape may refer to the shape of the plates from the perspective of the faces of the sheets. Flexible cross-sectional shapes and sizes allow preparation of the assemblies disclosed to accommodate the voltage and size needs of the system in which the batteries are utilized. Opposing end plates may sandwich a plurality of electrode plates therebetween. The one or more electrode plates may include one or more nonplanar structures such as described in PCT Application No. PCT/US2018/033435, incorporated herein by reference in its entirety.

One or more electrode plates may include one or more bipolar plates. The one or more bipolar plates may include a single or a plurality of bipolar plates. Plurality as used herein means that there are more than one of the plates. A bipolar plate comprises a substrate. The substrate may be in the form of a sheet having two opposing faces. The substrate may include one or more active materials on the opposing faces. The one or more active materials may include a cathode and an anode. The one or more active materials may be in the form of a paste applied onto the substrate. The one or more active materials may include a transfer sheet thereon. The bipolar plates may be arranged in a battery assembly in one or more stacks so that the cathode of one bipolar plate faces the anode of another bipolar, monopolar, or dual polar plate, and the anode of each bipolar plate faces the cathode of a another bipolar, monopolar, or dual polar plate.

One or more electrode plates may be one or more monopolar plates. The one or more monopolar plates may include a single or a plurality of monopolar plates. The one or more monopolar plates may include a monopolar plate located at each opposing end of a plurality of electrode plates. The one or more monopolar plates may include a first monopolar plate and as second monopolar plate. Opposing monopolar plates may include one or more bipolar plates located therebetween. One or more monopolar plates may be located adjacent to, may be part of, or may be one or more end plates. For example, each of the monopolar plates may be located between an adjacent end plate and an adjacent bipolar plate. One or more monopolar plates may be attached to one or more end plates. One or more monopolar end plates may be integral with an end plate. As another example, the one or more monopolar plates may be one or more end plates located at opposing ends of the battery assembly. One or more monopolar end plates may include one or more internal reinforcements. One or more monopolar plates may be prepared from the same substrates, active material, or both as used in one or more of the bipolar plates. A monopolar plate may have one or more active materials disposed only on one surface of a substrate while the opposing surface is free of any active materials. One monopolar plate of a battery assembly may have a substrate with a cathode disposed thereon. One monopolar plate of a battery assembly may have a substrate with an anode disposed thereon.

One or more electrode plates may include one or more dual polar plates. A dual polar plate may function to facilitate electrically connecting one or more stacks of electrode plates with one or more other stacks of electrode plates, simplify manufacturing and assembly of the two or more stacks, or both. Using one or more dual polar plates to electrically connect two or more stacks of electrode plates may allow the individual stacks of electrode plates to be formed as a standard size (e.g., number of plates and/or electrochemical cells) and then assembled to form the bipolar battery assembly; easily vary the number of individual stacks of electrode plates to increase or decrease the power generated by the bipolar battery assembly; or both. The dual polar plates may include one or more substrates. One or more substrates may include a single substrate or a plurality of substrates. One or more substrates may include one or more conductive substrates, one or more non-conductive substrates, or a combination of both. A plurality of conductive substrates may include a first conductive substrate and a second conductive substrate. For example, a dual polar plate may comprise a first conductive substrate and a second conductive substrate with a nonconductive substrate located therebetween. As another example, the dual polar plate may comprise a nonconductive substrate. As another example, the dual polar plate may comprise a single conductive substrate. The one or more substrates of the dual polar plate include opposing surfaces. The opposing surfaces may have an anode, cathode, current collector, current conductor, current conduit, or any combination thereof deposited and/or in contact with a portion of the surface. A conductive substrate of the dual polar plate may have one or more active materials deposited on a surface or on both opposing surfaces. Having the same one or more active materials and/or polarity of active materials (e.g., anode or cathode) on the opposing surfaces may simplify manufacturing by requiring only one electrical connection (e.g., via a positive or negative current conductor) to another current conductor (e.g., current collector, conductor, conduit, terminal) of the one or more stacks (e.g., a positive or negative current conductor, collector, conduit, or terminal of a monopolar plate). A substrate of the dual polar plate may have a current collector disposed on one or both opposing surfaces. The current collector may be disposed between the cathode or the anode and a surface of the substrate. Exemplary dual polar plates and integration into a battery assembly are disclosed in U.S. Pat. Nos. 9,685,677; 9,825,336; and US Patent Application Publication No.: 2018/0053926; incorporated herein by reference in their entirety for all purposes.

One or more electrode plates may include one or more substrates. One or more substrates may function to provide structural support for one or more active materials; as a cell partition so as to prevent the flow of electrolyte between adjacent electrochemical cells; cooperating with other battery components to form an electrolyte-tight seal about the bipolar plate edges which may be on the outside surface of the battery; as a support for one or more inserts and/or channels; and in some embodiments to transmit electrons from one surface to the other. The substrate can be formed from a variety of materials depending on the function or the battery chemistry. The substrate may be formed from materials that are sufficiently structurally robust to provide the backbone of a desired bipolar electrode plate, withstanding temperatures that exceed the melting points of any conductive materials used in the battery construction, and having high chemical stability during contact with an electrolyte (e.g., sulfuric acid solution) so that the substrate does not degrade upon contact with an electrolyte. The substrate may be formed from suitable materials and/or is configured in a manner that permits the transmission of electricity from one surface of the substrate to an opposite substrate surface. The substrate may be formed from an electrically conductive material, e.g., a metallic material, or can be formed from an electrically non-conductive material. Exemplary non-conductive material may include one or more polymers; such as thermoset polymers, elastomeric polymers or thermoplastic polymers, or any combination thereof. The non-conductive substrate may have electrically conductive features constructed therein or thereon. Examples of polymeric materials that may be employed include polyamide, polyester, polystyrene, polyethylene (including polyethylene terephthalate, high density polyethylene and low density polyethylene), polycarbonates (PC), polypropylene, polyvinyl chloride, bio-based plastics/biopolymers (e.g., polylactic acid), silicone, acrylonitrile butadiene styrene (ABS), or any combination thereof, such as PC/ABS (blends of polycarbonates and acrylonitrile butadiene styrenes). Composite substrates may be utilized, the composite may contain reinforcing materials, such as fibers or fillers commonly known in the art, two different polymeric materials such as a thermoset core and a thermoplastic shell or thermoplastic edge about the periphery of the thermoset polymer, or conductive material disposed in a non-conductive polymer. The substrate may comprise or have at the edge of the plates a thermoplastic material that is bondable, preferably melt bondable.

One or more substrates may have one or more frames. The one or more frames may facilitate stacking and/or interlocking of a plurality of electrode plates to form one or more electrochemical cells. The one or more frames may be located around all or at least a portion of a periphery of the one or more substrates. The one or more frames may include one or more raised edges. A frame may be located about the substrate, may retain the substrate, may be integral with the substrate, or a combination thereof. One or more frames of one or more electrode plates may align and interlock with one or more frames of one or more adjacent separators, adjacent electrode plates, or both to form a seal about one or more electrochemical cells. One or more exemplary frames are disclosed in U.S. Pat. No. 10,141,598 and PCT Publication Nos. WO 2018/213730, WO 2020/102677, and WO 2020/243093 incorporated herein by reference in their entirety.

One or more electrode plates, end plates, or both may include a sealing surface. The sealing surface may function to cooperate with one or more posts to compress and seal a stack of electrode plates. The sealing surface may be a surface of the electrode plate and/or end plate adjacent to one or more openings of an electrode plate and/or end plate, a surface of an electrode plate and/or end plate adjacent to a channel, a surface of the electrode plate and/or end plate between an insert and an opening, a surface of an insert, or any combination thereof. A sealing surface may be a surface of an electrode plate and/or end plate in direct contact with a portion of a post, such as an overlapping portion. A sealing surface may be opposing a surface of the end plate facing and/or in contact with a monopolar plate. A sealing surface may be opposing a surface of a monopolar plate facing a bipolar plate. The sealing surface of the electrode plate and/or end plate may be modified to improve sealing when compression is applied by the posts. The sealing surface may be smoothed, contoured, roughened or surface treated. A smooth surface will have large contact area from which to make an electrolyte tight seal without defects that allow liquid flow. Contours such as concentric ring(s), ridge(s) or undulations cause areas or “rings” of high pressure contact to resist the flow of liquid electrolyte. The ridge may be filled with a gasket material such as a deformable flat sheet or O-ring to facilitate liquid sealing. Rough sealing surfaces of a deformable material can compress to form reliable liquid electrolyte seal. Surface treating the sealing surface to make it incompatible to wetting by the liquid electrolyte will prevent liquid electrolyte flow into the channel. If a hydrophilic electrolyte is used the sealing surface can be made hydrophobic. Likewise, if a hydrophobic electrolyte is used the sealing surface should be hydrophilic.

The one or more electrode plates, end plates, or both may include one or more attachment mechanisms. One or more attachment mechanisms may function to attach one or more end plates to one or more electrode plates, a stack of electrode plates, or both. The end plate being attached to one or more electrode plates or one or more end plates may prevent deformation of one or more electrode plates during vacuum drawing, filling, venting, cooling, heating, charging, and/or discharging of one or more electrochemical cells before, during, and/or after operation of the battery. One or more end plates may be attached to one or more electrode plates, a stack of electrode plates, or both through any type of attachment mechanism able to withstand deformation forces before, after, or during operation of the battery. One or more attachment mechanisms may attach one or more end plates about at least a portion of a periphery of an end plate to an electrode plate, at least a portion of an interior of end plate to an electrode plate, or both. One or more attachment mechanisms may be any attachment mechanism capable of interlocking plastic to metal, plastic to plastic, metal to metal, or any combination thereof. The one or more attachment mechanisms may be integral with or separate from an end plate and/or an electrode plate. The one or more attachment mechanisms may attach to an exterior surface of an electrode plate, pass at least partially through one or more electrode plates, project from the end plate toward and/or into an electrode plate, project from an electrode plate toward and/or into an end plate, or any combination thereof. The one or more attachment mechanisms may be received in an opening of an end plate, an electrode plate, or both. One or more attachment mechanisms may include one or more adhesive materials, mechanical fasteners, molded fasteners, the like, or any combination thereof. A mechanical fastener may include a threaded fastener, a clip, a staple, the like, or any combination thereof. A threaded fastener may include a screw, a bolt, a stud, a nut, the like, or any combination thereof. An adhesive material may include an adhesive, a sealant, a tape, the like, or any combination thereof. Adhesive may include an epoxy, an acrylic, a urethane, the like, or any combination thereof. A tape may include very high bond tape, double sided tape, the like, or any combination thereof. A molded fastener may include a heat stake, a weld, the like, or any combination thereof. A clip may include a snap-fit, a press-fit, cantilever clip, clip with a hook face.

One or more of the electrode plates may include one or more active materials. The one or more active materials may function as a cathode, an anode, or both of the electrode plate. The one or more active materials may be any form commonly used in batteries to function as an anode, cathode, or both. A bipolar plate may have one or more active materials on a surface functioning as a cathode and one or more active materials on an opposing surface functioning as an anode. A monopolar plate may have one or more active materials on a surface functioning as a cathode or an anode while the opposing surface is bare of both an anode and cathode. A dual polar plate may have one or more active materials on a surface functioning as a cathode or an anode, while one or more similar active materials are on the opposing surface also functioning as a cathode or an anode. The cathode of one electrode plate may be opposing the anode of another electrode plate. The cathode may be referred to as one or more positive active materials (PAM). The anode may be referred to as one or more negative active materials (NAM). The one or more active materials may include any suitable active material which facilitates an electrochemical reaction with the electrolyte, the opposing one or more active materials, or both of the same electrochemical cell. The one or more active materials may be selected to have a reduction and/or oxidation reaction with the electrolyte.

The one or more active materials may comprise one or more materials typically used in secondary batteries, including lead acid, lithium ion, and/or nickel metal hydride batteries. The one or more active materials may comprise a composite oxide, a sulfate compound, or a phosphate compound of lithium, lead, carbon, or a transition metal. Examples of the composite oxides include Li/Co based composite oxide, such as LiCoO₂; Li/Ni based composite oxide, such as LiNiO₂; Li/Mn based composite oxide, such as spinel LiMn₂O₄, and Li/Fe based composite materials, such as LiFeO₂. Exemplary phosphate and sulfur compounds of transition metal and lithium include LiFePO₄, V₂O₅, MnO₂, TiS₂, MoS₂, MoO₃, PbO₂, AgO, NiOOH, and the like. For example, in a lead acid battery, the one or more active materials may be or include lead dioxide (PbO₂), tribasic lead oxide (3PbO), tribasic lead sulfate (3PbO.3PbSO₄), tetrabasic lead oxide (4PbO), tetrabasic lead sulfate (4PbO.4PbSO₄), or any combination thereof. The one or more active materials may be in any form which allows the one or more active materials to function as a cathode, anode, or both of an electrochemical cell. Exemplary forms include formed parts, in paste form, pre-fabricated sheet or film, sponge, or any combination thereof. For example, one or more active materials may include a sponge lead. Sponge lead may be useful due to its porosity. One or more suitable active materials and/or forms thereof may be described in PCT Patent Application No.: PCT/US2019/061725, incorporated herein by reference in its entirety for all purposes.

The battery assembly may include one or more electrochemical cells. An electrochemical cell may be formed by a pair of opposing electrode plates with an opposing anode and cathode pair therebetween. One or more electrochemical cells may be sealed. The space of an electrochemical cell (i.e., between an opposing anode and cathode pair) may contain an electrolyte. The electrochemical cells may be sealed through one or more seals formed about one or more channels, one or more frames of the electrode plates and/or separators, or a combination thereof. One or more seals may form one or more closed electrochemical cells. The closed electrochemical cells may be sealed from the environment to prevent leakage and short circuiting of the cells.

The battery assembly may include an electrolyte. The electrolyte may allow electrons and ions to flow between the anode and cathode. The electrolyte may be located within the electrochemical cells, between each pair of electrode plates. As the one or more electrochemical cells may be sealed, the electrolyte may be a liquid electrolyte. The electrolyte can be any liquid electrolyte that facilitates an electrochemical reaction with the anode and cathode utilized. The electrolytes can be water based or organic based. The organic based electrolytes useful herein comprises an electrolyte salt dissolved in an organic solvent. In lithium-ion secondary batteries, it is required that lithium be contained in the electrolyte salt. For the lithium-containing electrolyte salt, for instance, use may be made of LiPF₆, LiClO₄, LiBF₄, LiAsF₆, LiSO₃CF₃ and LiN(CF₃SO₂)₂. These electrolyte salts may be used alone or in combination of two or more. The organic solvent should be compatible with the separator, cathode and anode and the electrolyte salt. It is preferable to use an organic solvent that does not decompose even when high voltage is applied thereto. For instance, it is preferable to use carbonates such as ethylene carbonate (EC), propylene carbonate (PC), butylene carbonate, dimethyl carbonate (DMC), diethyl carbonate and ethyl methyl carbonate; cyclic ethers such as tetrahydrofuran (THF) and 2-methyltetrahydrofuran; cyclic esters such as 1,3-dioxolane and 4-methyldioxolane; lactones such as γ-butyrolactone; sulfolane; 3-methylsulfolane; dimethoxyethane, diethoxyethane, ethoxymethoxymethane and ethyldiglyme. These solvents may be used alone or in combination of two or more. The concentration of the electrolyte in the liquid electrolyte should preferably be 0.3 to 5 mol/l. Usually, the electrolyte shows the highest conductivity in the vicinity of 1 mol/l. The liquid electrolyte should preferably account for 30 to 70 percent by weight, and especially 40 to 60 percent by weight of the electrolyte. Aqueous electrolytes comprise acids or salts in water which enhance the functioning of the cell. Preferred salts and acids include sulfuric acid, sodium sulfate or potassium sulfate salts. The salt or acid is present in a sufficient amount to facilitate the operation of the cell. The concentration may be about 0.5 weight percent of greater based on the weight of the electrolyte, about 1.0 or greater or about 1.5 weight percent or greater. A preferred electrolyte in a lead acid battery is sulfuric acid in water. The electrolyte may be able to pass through a separator of an electrochemical cell.

The battery assembly may include one or more separators. The one or more separators may function to partition an electrochemical cell (i.e., separate a cathode an electrochemical cell from an anode of an electrochemical cell); prevent short circuiting of the cells due to dendrite formation; functions to allow liquid electrolyte, ions, electrons, or any combination of these elements to pass through it; or any combination thereof. Any known battery separator which performs one or more of the recited functions may be utilized in the assemblies of the invention. One or more separators may be located between anode and a cathode of an electrochemical cell. One or more separators may be located between a pair of adjacent electrode plates, which may include between bipolar plates, between a bipolar plate and a monopolar plate, or between a bipolar plate and dual polar plate. The separator may be prepared from a non-conductive material, such as porous polymer films, glass mats, porous rubbers, ionically conductive gels, or natural materials, such as wood, and the like. The separator may include one or more openings. The one or more openings may align with one or more openings of electrode plates. The separator may contain pores or tortuous paths through the separator which allows electrolyte, ions, electrons, or a combination thereof to pass through the separator. Among exemplary materials useful as separators are absorbent glass mats, and porous ultra-high molecular weight polyolefin membranes and the like. The separators may be attached about their periphery and/or interior to one or more end plates, electrode plates, other separators, or any combination thereof. The separators may receive one or more attachment mechanisms, posts, or both. For example, one or more attachment mechanisms and/or posts extending through a stack of one or more end plates, one or more electrode plates, and/or one or more separators may retain a stack of a plurality of electrode plates and one or more separators together. One or more attachment mechanisms may be located about a periphery of the separator, immediately adjacent a frame of a separator, between a frame and an opening of a separator, or any combination thereof. The separators may have an area that is greater than the area of the adjacent cathode and anode. The separator may completely separate the cathode portion of the cell from the anode portion of the cell. The edges of the separator may contact peripheral edges and/or frames of adjacent electrode plates, which may not have an anode or cathode disposed thereupon, so as to completely separate the anode portion of the cell from the cathode portion of the cell. One or more exemplary separators, such as with frames, are disclosed in U.S. Pat. No. 10,141,598 while one or more suitable transfer sheets suitable as separators are disclosed in PCT Publication No. WO 2018/213730, both incorporated herein by reference in their entirety.

One or more separators may include or be free of a frame. If frames are present, the frames may function to match with the edges or frames of adjacent electrode plates and form a seal between the electrochemical cells and the outside of the battery. One or more separator frames may be substantially similar to one or more frames of one or more electrode plates.

One or more electrode plates, end plates, separators, or a combination thereof may include one or more openings. The one or more openings may function to provide an opening for an attachment mechanism to pass therethrough; cooperate with one or more electrode plates, separators, end plates, and/or inserts to form part of one or more channels; house or be part of one or more seals; allow for vacuum pulling, filling, and/or venting of the battery assembly; provide for circulation of a fluid through one or more channels; retain one or more electrically conductive materials; or any combination thereof. The one or more openings may have any size, shape, and/or configuration to provide any combination of the desired functions. The one or more openings may have any combination of the features as described for openings and/or holes in one or more electrode plates, end plates, and/or substrates. One or more openings of one or more electrode plates, end plates, and/or separators may align (i.e., be concentric) with one or more openings of one or more other electrode plates, end plates, and/or separators so as to form one or more channels. Alignment may be in a transverse direction. Transverse may mean substantially perpendicular to a face of a substrate and/or separator, across a length of the battery assembly, parallel to a longitudinal axis of the battery assembly, or a combination thereof. The transverse direction may be substantially perpendicular the opposing surfaces of the substrates upon which a cathode and/or anode may be deposited. Transverse may mean that the general width, diameter, or both of a cross-section of the one or more openings is substantially parallel to a face of a substrate and/or separator. One or more openings of an electrode plate, end plate, and/or substrate may have a shape and/or size similar to one or more openings of another electrode plate, end plate, and/or separator which may be adjacent. The one or more openings may have a cross-sectional shape which functions to receive an attachment mechanism, receive a post, cooperate with an insert, or any combination of the desired functions of the openings and may be generally rectangular, circular, triangular, elliptical, ovular, or any combination thereof. The one or more openings may have a cross-sectional width sufficient to receive one or more attachment mechanisms, one or more posts, one or more valves, or any combination thereof. The openings may be machined (e.g., milled), formed during fabrication of the substrate (e.g., by a molding or shaping operation), or otherwise fabricated. The openings may have straight and/or smooth internal walls or surfaces. The size and frequency of the openings formed in the substrate may affect the resistivity of the battery. One or more openings may have a cross-sectional width less than, equal to, or greater than a diameter of one or more openings formed within the same end plate and/or an adjacent electrode plate. A cross-sectional width of one or more openings may be continuous, taper, or expand along a length of an opening. A cross-sectional width of one or more openings may be suitable for receive one or more posts, rods, fluids, electrolyte, or a combination thereof therethrough. The one or more openings may have a cross-sectional width of about 0.2 mm or more, 1 mm or more, about 3 mm or more, or even about 5 mm or more. The one or more openings may have a cross-sectional width of about 30 mm or less, about 25 mm or less, or even about 20 mm or less. A cross-sectional width of an opening may be considered the same as a diameter of an opening. The one or more openings may pass partially or completely through an insert, a base, a substrate, a separator, a reinforcement structure, a rib structure, or any combination thereof. The one or more openings may include one or more inserted located and/or formed therein. The one or more openings may be located about or adjacent a periphery, within an interior, or both of an end plate, electrode plate, separator, or combination thereof. The one or more openings may be distributed about a periphery, within an interior defined within the periphery, or both of an end plate, electrode plate, separator, or a combination thereof. The one or more openings may be located adjacent to one or more rib structures, between two or more rib structures, within a cell, adjacent one or more inserts, within one or more inserts, or any combination thereof. The one or more openings may form a repetitive pattern, may be aligned with one or more other openings, may be staggered or offset from one or more other openings, or any combination thereof. One or more openings of an electrode plate, end plate, and/or substrate may have a larger diameter than one or more other openings of the same electrode plate, end plate, and/or substrate. An opening may be about at least about 1.5 times, at least about 2 times, or even at least about 2.5 times larger than another opening. An opening may be about 4 times or less, about 3.5 times or less, or even about 3 times or less larger than another opening. The openings may be formed having a density of at least about 0.02 openings per cm². The openings may be formed having a density of less than about 4 openings per cm². The openings may be formed having a density from about 2.0 openings per cm² to about 2.8 openings per cm². The one or more openings may include one or more peripheral openings, one or more internal openings, one or more channel openings, one or more conductive openings, the like, or any combination thereof.

One or more openings may include one or more peripheral openings. The one or more peripheral openings may function to receive and cooperate with one or more attachment mechanisms to secure at least a portion of a periphery of an end plate, electrode plate, or both to at least a portion of a periphery of an electrode plate. Attachment about at least a portion of a periphery of the end plate, electrode plate, or both to an adjacent electrode plate may apply a compressive force about a periphery of one or more electrode plates. The compressive force about the periphery during operation of the battery may resist outward bulging of one or more electrode plates. The compressive force about the periphery while drawing a vacuum within the battery may resist inward bending of one or more electrode plates, which may maintain one or more seals about one or more edges of the stack of electrode plates. The one or more peripheral openings may be located adjacent an outer reinforcement rib structure; within an interior of an end plate, electrode plate, and/or separator; within a cell; or any combination thereof. The one or more peripheral openings may be aligned or offset from one or more other openings. For example, one or more peripheral openings may be aligned with one or more other peripheral openings in a line substantially parallel to one or more rib structures. For example, one or more peripheral openings may be offset from an aligned plurality of internal openings and/or channel openings. One or more peripheral openings may have any cross-sectional width or diameter through which an attachment mechanism is able to pass through, to or from an adjacent electrode plate. One or more peripheral openings may be smaller than, equal to, or larger than one or more other openings. For example, one or more peripheral openings may be smaller than one or more channel openings.

One or more openings may include one or more internal openings. The one or more internal openings may function to receive and cooperate with one or more attachment mechanisms to secure at least a portion of an interior of an end plate, electrode plate, or both to at least a portion of an interior of an electrode plate. An interior of an electrode plate may be defined as a portion of the electrode plate or substrate of an electrode plate located between raised edges, a frame, a periphery, or a combination thereof of the electrode plate. Attachment about at least a portion of an interior of an end plate, electrode plate, or both to an adjacent electrode plate may apply a compressive force about an interior of one or more electrode plates. The compressive force within the interior of an electrode plate during operation of the battery may resist outward bulging of one or more electrode plates. The compressive force within the interior of an electrode plate while drawing a vacuum within the battery may resist inward bulging of one or more electrode plates. The one or more internal openings may be located adjacent or distanced from one or more reinforcement rib structures; within an interior of an end plate, electrode plate, separator, or a combination thereof; within a cell, or any combination thereof. The one or more internal openings may be aligned or offset from one or more other openings. For example, one or more internal openings may be aligned with one or more other internal openings in a line substantially parallel to one or more rib structures. For example, one or more internal openings may be offset from an aligned plurality of internal openings and/or channel openings. One or more internal openings may have any cross-sectional width or diameter through which an attachment mechanism is able to pass through, to or from an adjacent electrode plate. One or more internal openings may be smaller than, equal to, or larger than one or more other openings. For example, one or more internal openings may be smaller than one or more channel openings.

One or more openings may include one or more channel openings. The one or more channel openings may function to align with one or more openings of one or more electrode plates to form one or more channels; provide an opening for venting, filling, and/or venting the battery assembly; providing an opening for circulating one or more fluids within an interior of the battery assembly; cooperate with one or more valves, receive one or more posts to compress the stack of electrode plates; receive one or more rods; or any combination thereof. The one or more channel openings may align (i.e., concentric alignment) with one or more openings and/or holes of one or more electrode plates, end plates, and/or separators in a transverse direction to form one or more channels through the stack. The one or more channel openings may have a size substantially equal to one or more holes of one or more other electrode plates, end plates, and/or separators. The one or more channel openings may have any size through which one or more posts, rods, fluids, or a combination may pass through. One or more channel openings may have a smaller, equal, or larger cross-sectional width or area than one or more other channel openings. For example, one channel opening may have a larger diameter than one or more other channel openings to allow for filling, venting, cooling, and/or heating of the battery. One or more channel openings may be connected to or in communication with one or more valves. For example, a channel opening having a larger diameter than other channel openings may be connected to a valve. A surface of the base near and/or adjacent to one or more channel openings may be a sealing surface.

One or more openings may include one or more conductive openings. One or more conductive openings may be filled with an electrically conductive material, e.g., a metallic-containing material. The one or more conductive openings may be formed in one or more electrode plates, end plates, substrates, or a combination thereof. The electrically conductive material may be a material that undergoes a phase transformation at a temperature that is below the thermal degradation temperature of the substrate so that at an operating temperature of the battery assembly that is below the phase transformation temperature, the dielectric substrate has an electrically conductive path via the material admixture between the first surface and the second surface of the substrate. Further, at a temperature that is above the phase transformation temperature, the electrically conductive material admixture undergoes a phase transformation that disables electrical conductivity via the electrically conductive path. For instance, the electrically conductive material may be or include a solder material, e.g., one comprising at least one or a mixture of any two or more of lead, tin, nickel, zinc, lithium, antimony, copper, bismuth, indium, or silver. The electrically conductive material may be substantially free of any lead (i.e., it contains at most trace amounts of lead) or it may include lead in a functionally operative amount. The material may include a mixture of lead and tin. For example, it may include a major portion tin and a minor portion of lead (e.g., about 55 to about 65 parts by weight tin and about 35 to about 45 parts by weight lead). The material may exhibit a melting temperature that is below about 240° C., below about 230° C., below about 220° C., below 210° C. or even below about 200° C. (e.g., in the range of about 180 to about 190° C.). The material may include a eutectic mixture. A feature of using solder as the electrically conductive material for filling the openings is that the solder has a defined melting temperature that can be tailored, depending on the type of solder used, to melt at a temperature that may be unsafe for continued battery operation. Once the solder melts, the substrate opening containing the melted solder is no longer electrically conductive and an open circuit results within the electrode plate. An open circuit may operate to dramatically increase the resistance within the bipolar battery thereby stopping further electrical flow and shutting down unsafe reactions within the battery. Accordingly, the type of electrically conductive material selected fill the openings can vary depending on whether it is desired to include such an internal shut down mechanism within the battery, and if so at what temperature it is desired to effect such an internal shutdown. The substrate will be configured so that in the event of operating conditions that exceed a predetermined condition, the substrate will function to disable operation of the battery by disrupting electrical conductivity through the substrate. For example, the electrically conductive material filling holes in a dielectric substrate will undergo a phase transformation (e.g., it will melt) so that electrical conductivity across the substrate is disrupted. The extent of the disruption may be to partially or even entirely render the function of conducting electricity through the substrate disabled. One or more conductive openings may be smaller than or equal in size (e.g., in diameter) to one or more other openings of an end plate, electrode plate, substrate, or a combination thereof. One or more conductive openings may have a diameter that is about 1% or greater, 5% or greater, 10% or greater, or even about 25% or greater as compared to a diameter of one or more other openings (e.g., channel openings, peripheral openings, internal openings). One or more conductive openings may have a diameter about 75% or less, about 50% or less, or even about 40% or less as compared to a diameter of one or more other openings.

One or more electrode plates, end plates, separators, or any combination thereof may include one or more inserts. The one or more inserts may function to interlock with one or more inserts of another electrode plate, end plate, separator, or a combination thereof; to define a portion of one or more channels passing through the stack; forming a leak proof seal along one or more channels; cooperate with one or more valves; providing a housing for one or more tubular members, including one or more posts and/or rods; allow for a fluid to pass therethrough; or any combination thereof. The one or more inserts may have any size and/or shape to interlock with one or more inserts of an electrode plate, end plate, and/or separator; form a portion of a channel; form a leak proof seal along one or more channels; cooperate with one or more valves; or any combination thereof. The one or more inserts may be integral with or attached to an electrode plate, end plate, separator, or a combination thereof. The one or more inserts may be integral with or attached to a substrate, base, or both. The one or more inserts may be formed as one or more bosses. An insert which is integral with a surface of an end plate (e.g., base), electrode plate (e.g., substrate), and/or separator (e.g., sheet) and projects from that surface may be defined as a boss. The one or more inserts may be integrally formed through compressive forming, tensile forming, molding, or the like, or any combination thereof. Compressive forming may include die forming, extrusion, indenting, the like, or any combination thereof. Molding may include injection molding. Where an electrode plate, end plate, and/or separator has both inserts and a frame, raised edges, and/or a recessed portion, these parts may be molded in one step, for instance by injection molding. One or more inserts may project from a surface of an end plate, electrode plate, and/or separator thus forming one or more raised inserts. One or more inserts may project from a base of an end plate, substrate of an electrode plate, a surface of a separator, or any combination thereof. One or more inserts may project in a same or opposing direction as one or more rib structures, frames, or both from a base, substrate, or both. One or more inserts may have the same height and/or thickness as one or more rib structures, frames, one or more other inserts, or a combination thereof. One or more inserts may project substantially orthogonally or oblique from a surface of the base, substrate, separator, or a combination thereof. The one or more inserts may have one or more openings therethrough. The one or more inserts may have one or more peripheral openings, internal openings, channel openings, or a combination thereof therethrough. The one or more inserts may be concentric and formed about one or more openings. One or more inserts may extend a length of an opening (e.g., an opening may pass entirely through an insert). One or more inserts may pass through one or more openings. For example, one or more inserts of one or more electrode plates may pass through one or more openings of one or more separators to align and interlock with one or more inserts of another electrode plate. One or more inserts mate with one or more other inserts to form one or more channels, seal the one or more channels from the liquid electrolyte, or both. A sealing surface may be formed between the outer diameter of one or more openings and an interior of one or more inserts. For example, a surface of the base and/or substrate substantially perpendicular to a longitudinal axis of the battery located between an insert and an opening may be a sealing surface. One or more inserts may be capable of interlocking with one or more inserts of an adjacent electrode plate, separator, and/or end plate to form a leak proof seal about a channel. For example, one or more end plates and/or electrode plates may be machined or formed to contain matching indents, on a surface opposite from an insert, for inserts, sleeves, or bushings of an adjacent electrode plate and/or separator. The inserts may contain one or more vent holes. Inserts in one or more separators may contain one or more vent holes. The vent holes may allow communication between one or more electrochemical cells and one or more channels. One or more vent holes may allow transmission of gasses from one or more electrochemical cells to one or more channels and prevent the transmission of one or more liquids (i.e., an electrolyte) from one or more electrochemical cells to one or more channels.

The battery assembly may include one or more channels. The one or more channels may function as one or more venting, filling, cooling, and/or heating channels; house one or more posts and/or rods; distribute one or more posts and/or rods throughout an interior of the battery assembly; distribute compressive forces throughout an interior of the battery assembly such as by passing through one or more active materials; prevent liquid electrolyte from coming into contact with one or more posts, rods, or other components; allow for circulation of one or more fluids within an interior of the battery assembly; or any combination thereof. The one or more channels may be formed by one or more openings and/or inserts of one or more end plates, electrode plates, and/or separators which are aligned with one another. The one or more channels may be formed by one or more channel openings of one or more end plates, electrode plates, and/or separators aligned with one or more channels openings of other (e.g., adjacent) end plates, electrode plates, and/or separators. The one or more channels may be referred to as one or more integrated channels, transverse channels, cooling channels, venting/filling channels, or a combination thereof. The one or more channels may pass through one or more electrochemical cells. By passing through one or more electrochemical cells, the one or more channels may also pass through a liquid electrolyte, active material, or both. The channels may be sealed to prevent electrolyte and gasses evolved during operation from entering the channels. Any method of sealing which achieves this objective may be utilized. The one or more seals may include one or more seals therein. The one or more seals may seal the one or more channels from a liquid electrolyte. One or more seals, such as inserts, of the one or more end plates, electrode plates, and/or separators may interlock and surround one or more channels to prevent the liquid electrolyte from leaking into one or more channels. The one or more channels may pass through the battery assembly in a transverse direction to form one or more transverse channels. The one or more channels may pass transversely through the plurality of electrode plates and a liquid electrolyte. The one or more channels may be comprised of series of openings in the components. A series of openings may be arranged so a tubular member, such as a post and/or rod can be placed in the channel formed; a fluid can be transmitted through the channel for cooling and/or heating; for venting; for filling with a liquid electrolyte; or any combination thereof. One or more channels having one or more fluids passed therethrough may be referred to as one or more cooling channels.

One or more cooling channels may be configured to remove heat from an interior of the battery assembly. One or more cooling channels may include, be in communication with, or both, one or more heat exchangers.

The size and shape of the channels can be any size or shape which allows them to house one or more posts. The cross-sectional shape of the channels may be round, elliptical, or polygonal, such as square, rectangular, hexagonal and the like. The cross-sectional shape may be determined by the cross-sectional shape of the one or more openings and/or inserts. The size of the channels housing one or more posts and/or rods is chosen to accommodate the posts and/or rods used. The diameter of the channel may be equal to the diameter of the openings which align to form one or more channels. The number of channels may be chosen to support the end plate and edges of the end plates, electrode plates, and substrates to prevent leakage of electrolytes and gasses evolved during operation and to prevent the compressive forces arising during operation from damaging components and the seal for the individual electrochemical cells. A plurality of channels may be present so as to spread out the compressive forces generated during operation. The number and design of channels is sufficient to minimize edge-stress forces that exceed the fatigue strength of the seals. The locations of a plurality of channels are chosen so as to spread out the compressive forces generated during operation. The channels may be spread out evenly through the stack to better handle the stresses. The plurality of channels may have a cross-sectional size of about 2 mm or greater, about 4 mm or greater or about 6 mm or greater. The upper limit on the cross-sectional size of the channels is determined by practicality, if the size is too large the efficiency of the assemblies is reduced. The channels may have a cross-sectional size of about 30 mm or less, about 25 mm or less, or even about 20 mm or less.

The battery assembly may comprise a seal. The seal may function to prevent an electrolyte and/or gasses from entering one or more channels. A seal within one or more channels may function to increase a strength of the bipolar battery in a transverse direction. The seal may be located between one or more channels and one or more tubular members, may be a tubular member, may formed by one or more surfaces of one or more channels and/or tubular members, or both. One or more seals may be located in a channel, about an exterior of a channel, about the periphery of the channel, along all or part of a length of a channel, about a tubular member, or a combination thereof. One or more seals may extend along all or a portion of one or more channels, such as one or more channels in which the one or more seals are located. The seal may comprise any material or form that prevents electrolyte and gasses evolved during operation from leaking from the electrochemical cells into the channel, withstand operating conditions of a battery assembly, withstand forces exerted by one or more posts, or a combination thereof. The seal may comprise any material or form that prevents one or more fluids circulating through one or more channels from leaking into the electrochemical cells. The seal can be a membrane, sleeve, and/or series of matched inserts in the end plates, electrode plates, and/or separators or inserted in the channel. The one or more seals may be molded along one or more internal surfaces of one or more channels to seal the one or more channels from the liquid electrolyte. The one or more seals can be a thermoplastic, elastomeric, or both. The channel can be formed by a series of sleeves, bushings, inserts, or a combination thereof which are inserted or integrated into the end plates, electrode plates, and/or separators. One or more inserts may be compressible or capable of interlocking with one another to form a leak proof seal along the channel One or more inserts may be formed in place in the end plates, electrode plates, and/or separators. One or more inserts may be formed in place such as by molding them in place. One or more seals may be formed by one or more inward facing surfaces of one or more inserts, separate from the one or more inserts, or both. The preferred polymeric materials that are described as useful for the posts and the substrates may be useful for forming a seal. The seal may be formed by sleeves, inserts or bushings placed between the bipolar and monopolar plates. The sleeves or inserts can be relatively rigid and the bushings may be generally elastomeric. The inserts, sleeves, and/or bushings may be adapted to fit within indentations in the end plates, electrode plates, and/or separators or to have ends that insert into the openings of the plates creating one or more channels. The end plates and/or electrode plates can be formed or machined to contain matching indents for the inserts, sleeves and/or the bushings. Assembly of the stack of plates with the inserts, sleeves, or bushings may create interference fits to effectively seal the channels. Alternatively, the inserts, sleeves and/or bushings may be melt-bonded or adhesively bonded to the plates so as from a seal at the junction. Alternatively, inserts, sleeves and/or bushings may be coated in the inside with a coating which functions to seal the channel One or more tubular members may function to seal the channels. It is contemplated that a combination of these sealing solutions may be utilized in single channel or in different channels. The components of the stack of plates, including dual polar, monopolar plates and bipolar plates, preferably have the same shape and common edges. This facilitates sealing of the edges. Where separators are present, they generally have a similar structure as the electrode plates to accommodate the formation or creation of the transverse channels. In another embodiment, the seal may be a thermoset polymer, such as an epoxy, polyurethane or acrylic polymer injected between the bolt and the transverse channel One or more channels may be formed by inserts, sleeves and/or bushings bonded to, in openings, and/or integral with openings in one or more electrode plates and/or one or more separators. One or more posts in one or more channels may apply sufficient pressure to hold inserts, holes, sleeves and/or bushings in place to form a sealed passage. The one or more channels may be formed from inserts bonded and/or integrated into one or more electrode plates and one or more separators. One or more posts may be bonded to one or more inserts, substrates, and/or separators by an adhesive bond or by fusion of thermoplastic polymers or both. The inserts may be inserted into one or more electrode plates and/or separators by interference fit or bonded in place by an adhesive.

The battery assembly may include one or more tubular members. The one or more tubular members may function to hold the stack of components together in a fashion such that damage to components or breaking of the seal between the edges of the components of the stack is prevented, ensure uniform compression across the separator material, ensure uniform thickness of the separator material, provide for circulation of a fluid through one or more channels, or any combination thereof. The one or more tubular members may be formed as solid, partially solid, partially hollow, or completely hollow. A hollow tubular member may allow for one or more fluids to pass therethrough. A solid tubular member may provide for additional strength and reinforcement along a length of a battery assembly. The one or more tubular members may have one or more open ends, closed ends, or both. The one or more tubular members may or may not have a shape substantially reciprocal to one or more channels. The one or more tubular members may have one or more continuous walls, discontinuous walls, or both. Continuous may be an outer wall of a tubular member may be solid without one or more openings about its circumference and/or periphery. Continuous may still allow for one or both ends of the tubular member to be open and/or closed. Continuous may allow for one or more fluids to flow through a tubular member without leaking out of the tubular member into one or more electrochemical cells. Discontinuous may mean an outer wall of a tubular member may have one or more openings. One or more openings may align with one or more vents of one or more inserts. The one or more tubular members may include, be formed by, or both one or more posts, one or more rods, one or more seals, one or more sleeves, one or more inserts (e.g., aligned, interlocked), the like, or any combination thereof.

The one or more tubular members may comprise any material suitable for performing any of the necessary functions. One or more materials suitable may be a material suitable for withstanding operating conditions of one or more electrochemical cells. Withstanding operating conditions may include resisting corrosion when exposed to electrolyte, and withstanding temperatures and pressures generated during pickling, formation, and operation of the cells. The material may be conductive, nonconductive or both. A nonconductive material may be beneficial as it may prevent shorting out of electrochemical cells, such as when a separate seal is not located between the channel inner surface and the tubular member. The one or more tubular members may be comprised of one or more metals, metalloids, minerals, polymers, ceramics, organic compounds, or any combination thereof. The one or more tubular members may comprise a polymeric material, such as a thermoset polymer or a thermoplastic material. The one or more tubular members may comprise a thermoplastic material. Exemplary thermoplastic materials include ABS (acrylonitrile-butadiene-styrene copolymers), polypropylene, polyester, thermoplastic polyurethanes, polyolefins, compounded thermoplastic resins, polycarbonates, and the like. One or more metals may include steel, brass, aluminum, copper, the like, or a combination thereof. One or more metalloids may include boron, arsenic, the like, or a combination thereof (e.g., boron arsenide). One or more minerals may include diamond, graphene, the like, or a combination thereof. The one or more tubular members may or may not be useful in conducting heat. Thermal conductivity may be beneficial in heating, cooling, or both the battery assembly from within an interior. The one or more tubular members may have a high thermal conductivity. One or more tubular members may have a thermal conductivity of about 100 W/m·K or greater, about 150 W/m·K or greater, about 200 W/m·K or greater, or even about 250 W/m·K or greater. One or more tubular members may have a thermal conductivity of about 2500 W/m·K or less, about 2000 W/m·K or less, about 1500 W/m·K or less, or even about 1000 W/m·K or less.

The one or more tubular members may be located within the one or more channels. The one or more tubular members may be formed as part of one or more channels or separate from the one or more channels. The one or more tubular members may be formed as part of one or more channels such as by being molded in place within the one or more channels. One or more tubular members may be located in one, some, or all of the one or more channels. Differing tubular members may be located in some or all of the channels. For example, one or more channels may include one or more posts while one or more other channels include one or more seals and/or rods. One or more tubular members may be attached, partially attached, or completely detached from one or more inner surfaces of one or more channels. One or more mechanical fasteners, adhesive materials, molded fasteners, or a combination thereof may be used to at least partially attach one or more tubular members to one or more channels. One or more mechanical fasteners may include one or more tubing couplers, threads, an interference fit, the like, or a combination thereof. For example, an interior surface of a channel may be threaded, an exterior surface of a tubular member may be threaded, and the tubular member may have a threaded engagement with the channel. As another example, a tubing coupler may reside within a channel and receive a tubular member. A tubing coupler may be formed as part of, insert-molded within, molded directly within, inserted into, or a combination thereof one or more channels. One or more tubing couplers may be located on one or more ends of at least one of the one or more channels. One or more adhesive materials may include an adhesive, sealant, tape, or a combination thereof. One or more molded fasteners may be separate from or include one or more inserts. For example, the inward facing surfaces of one or more inserts (i.e., the peripheral surfaces of the openings) may be melt-bonded along a length of the channel to form the one or more tubular members. One or more methods of attaching one or more posts as discussed hereinafter may be suitable for affixing one or more tubular members within one or more channels. One or more tubular members may extend from a first side or end of a battery assembly to an opposing end. One or more tubular members may or may not be in communication with one or more valves.

The battery assembly may include one or more posts. The one or more posts may function to hold the stack of components together in a fashion such that damage to components or breaking of the seal between the edges of the components of the stack is prevented, ensure uniform compression across the separator material, and ensure uniform thickness of the separator material. The one or more posts may include, be, be located in, or a combination thereof one or more tubular members. The one or more posts may exhibit a cross-section shape and size so as to fill a channel. The one or more posts may be of a length to pass through the entire stack and such length may vary based on the desired capacity of the battery. The one or more posts may have a cross-sectional size smaller, equal to, or greater than the cross-sectional size of one or more channels. The posts may form an interference fit with one or more of the channels. The number of posts is chosen to support the end plates (e.g., end plates and/or monopolar plates) and edges of the substrates to prevent leakage of electrolytes and gasses evolved during operation and to prevent the compressive forces arising during operation from damaging components and the seal for the individual electrochemical cells, and to minimize edge-stress forces that exceed the fatigue strength of the seals. The plurality of posts may be present so as to spread out the compressive forces generated during operation. There may be fewer posts than channels where one or more of the channels are utilized as cooling channels, heating channels, venting channels, filling channels, or a combination thereof. For example, there may be four channels with three channels having a post located therein and one channel may be used as a cooling, heating, vent, and/or fill channel. As another example, one channel may be used as a cooling and/or heating, another channel may be used as a vent and/or fill channel, while one or more other channels have one or more posts located therein.

The one or more posts may have on each end an overlapping portion which engages the outside surface of opposing end plates, such as a sealing surface of each end plate. The overlapping portion may function to apply pressure on outside surfaces of opposing end plates in a manner so as to prevent damage to components or breaking of the seal between the edges of the components of the stack and prevent bulging or other displacements of the stack during battery operation. The overlapping portion may be in contact with a sealing surface of an end plate. The stack may have a separate structural or protective end-piece over the monopolar endplate and the overlapping portion will be in contact in with the outside surface of the structural or protective end-piece. The overlapping portion can be any structure that in conjunction with the post prevents damage to components or breaking of the seal between the edges of the components of the stack. Exemplary overlapping portions include bolt heads, nuts, molded heads, brads, cotter pins, shaft collars and the like.

The one or more posts can comprise one or more molded posts, threaded posts, and/or posts with one or more end attachments. The posts may be bonded to parts of the stacks. For example, the one or more posts may be molded to the substrates, inserts in the channels, one or more tubular members, and the like. The bonds can be formed from adhesives or fusion of the polymeric materials, such as thermoplastic materials. Where the parts are threaded, the structural parts of the stack are threaded to receive the threaded posts. Posts can have a head on one end and a nut, hole for a brad or cotter pin on the other or may have a nut, hole for a brad or cotter pin on both ends. This is generally the case for non-molded posts. The posts may be constructed in such a way as to be a one-way ratcheting device that allows shortening, but not lengthening. Such a post would be put in place, then as the stack is compressed, the post is shortened so that it maintains the pressure on the stack. The post in this embodiment may have ridges that facilitate the ratcheting so as to allow the posts to function as one part of a zip tie like structure. Matching nuts and/or washers may be used with posts so as to compress the plates they are adjacent to when in place. The nuts and/or washers go one way over the posts and ridges may be present to prevent the nuts and/or washers from moving the other direction along the posts. In use the holes in the posts will have the appropriate brads, cotter pins and the like to perform the recited function. If the post is molded is can be molded separately or in place. If molded in place, in situ, a seal needs to be present in the channel to hold the molten plastic in place. A nonconductive post which is threaded may be used and can provide the necessary seal. Alternatively, a pre-molded nonconductive polymeric post may be designed to form an interference fit in the channel in a manner so as seal the channels. The posts may be formed in place by molding, such as by injection molding.

The battery assembly may include one or more rods. The one or more rods may function to circulate one or more fluids through an interior of a battery assembly, provide cooling and/or heating of an interior within a battery assembly, reside within one or more channels, or a combination thereof. The one or more rods may include, be, be located in, or a combination thereof one or more tubular members. The one or more rods may be formed as solid, partially solid, or even hollow. The one or more rods may be formed as one or more hollow tubes, heat pipes, or both. The one or more rods may have one or more open ends, sealed ends, or both. For example, a rod may be hollow with opposing open ends. As another example, a rod may be hollow with opposing sealed ends. Sealed ends may allow for one or more fluids to be sealed within the one or more rods, circulate one or more fluids within the one or more rods, or both. One or more open ends may allow for one or more fluids to be added, removed, and/or circulated through the one or more rods. One or more rods may have a cross-sectional width (e.g., diameter) about equal to or smaller than a width or diameter of one or more openings (e.g., channel openings), channels, or both. The one or more rods may include one or more heat transfer materials, fluids, the like, or a combination thereof located within. One or more heat transfer materials may include one or more materials suitable for providing capillary action. One or more heat transfer materials may include one or more wicks. One or more heat transfer materials may work cooperate with one or more fluids to provide for the transfer of heat and thus heating, cooling, or both. The one or more rods may pass through an interior of a battery assembly, about a periphery of a battery assembly, or both. The one or more rods may extend along a transverse direction of a battery assembly. One or more rods may extend along all or a portion of a length of a channel, battery assembly, or both. The one or more rods may reside within one or more channels. The one or more rods may include a single rod or a plurality of rods. A plurality of rods may be disbursed throughout an interior of battery assembly. One or more channels may be filled with one or more posts while one or more other channels are filled with one or more rods. The one or more rods may have one or more features useful with or as the one or more posts (e.g., overlapping portion, threads, etc.). The one or more rods may form one or more seals, be located within one or more seals, or both. The one or more rods may be, may be located within, or both one or more tubular members.

The battery assembly may include one of more heat exchangers. The one or more heat exchangers may function to control a temperature, heat, cool, or a combination thereof a battery assembly. The one or more heat exchangers may control a temperature of a battery assembly from an exterior, interior, or a combination of both. One or more heat exchangers may be located about all or at least a portion of an exterior, an interior, or a combination thereof of the battery assembly. One or more heat exchangers may be affixed to at least a portion of an exterior of a battery assembly, an end plate, a monopolar plate, a membrane, a casing, as terminal cover, the like, or a combination thereof. One or more heat exchangers may include one or more active, passive, or both heat exchangers. One or more heat exchangers may include one or more fluid heat exchangers, shell and tube heat exchangers, plate heat exchangers, heat sinks, phase-change heat exchangers, waste heat recovery units, thermoelectric devices (“TED”), the like, or any combination thereof. One or more heat exchangers may be in communication with, located within, adjacent to, or a combination thereof one or more channels. One or more heat exchangers may include one or more tubular members, fluid contained within one or more tubular members and/or channels, one or more channels, or a combination thereof. For example, one or more tubular members located within one or more channels having fluid therethrough may be considered a heat exchanger. One or more fluids may be located within, circulated within, circulated through, or a combination thereof one or more channels. The one or more fluids may be configured to add heat, remove heat, or both from the bipolar battery. One or more channels having one or more fluids may be referred to as a cooling and/or heating channel One or more fluids may include one or more gases, liquids, or a combination thereof. One or more fluids may include air, water, ammonia, nitrogen, oxygen, neon, hydrogen, helium, refrigerant (e.g., 1,1,1,2-Tetrafluoroethane), alkali metal, heat exchange fluid, the like, or any combination thereof. For example, water may be located within one or more rods. As another example, air and/or water may flow through one or more tubular members. As another example, one or more heat sinks may be located at one or both ends of one or more channels, in communication with one or more tubular members, or both. One or more flow mechanisms may be in communication with one or more channels. The one or more flow mechanisms may function to create flow, circulation, or both of one or more fluids in one or more channels. The one or more flow mechanisms may include one or more pumps, fans, valves, the like, or any combination thereof. The one or more flow mechanisms may be temporarily, semi-permanently, or permanently affixed as part of the battery assembly. One or more flow mechanisms may be considered part of or separate from the one or more heat exchangers. One or more heat exchangers (such as a heat sink) located outside of a battery assembly and in communication with one or more channels may be beneficial in dissipating heat away from one or more channels and away from the battery assembly. One or more heat exchangers located within the battery assembly and having one or more fluids passing through the battery assembly (e.g., water, air, etc.) may be beneficial in dissipating heat away from the battery assembly, from the interior, or both. One or more heat exchangers may cooperate together to remove heat from within an interior of the battery assembly. For example, one or more heat exchangers within one or more channels may collect and move heat from an interior of the battery assembly toward one or more heat exchangers affixed to an outside of the battery assembly. One or more heat exchangers may be located adjacent to a membrane, between a membrane and an end plate, the membrane may be located between the heat exchanger and an end plate, or a combination thereof. As an alternative, there may be no membrane adjacent to one or more heat exchangers.

The battery assembly may include or be free of a membrane. The membrane may function to seal about the edges of one or more end plates, plurality of electrode plates, one or more separators, one or more channels, or any combination thereof. The membrane may be bonded to the edges of the one or more end plates, plurality of electrode plates, and/or one or more separators by any means that seals the edges of the end plates, electrode plates, and separators and isolates the one or more electrochemical cells. Exemplary bonding methods comprise adhesive bonding, melt bonding, vibration welding, RF welding, and microwave welding, among others. The membrane may be a sheet of a polymeric material which material can seal the edges of the end plates, monopolar plates, bipolar plates, and/or dual polar plates and can withstand exposure to the electrolyte and the conditions the battery is exposed to internally and externally. The same materials useful for the substrate of the electrode plates may be utilized for the membrane. The membrane may be a thermoplastic polymer that can be melt bonded, vibration welded or molded about the substrates of the monopolar and bipolar plates. The same thermoplastic polymer may be utilized for the monopolar and bipolar substrates and the membranes. Exemplary materials are polyethylene, polypropylene, ABS and, polyester, with ABS most preferred. The membranes may be the size of the side of the stacks to which they are bonded, and the membranes are bonded to each side of the stack. The edges of the adjacent membranes may be sealed. The edges can be sealed using adhesives, melt bonding or a molding process. The membranes may comprise a single unitary sheet which is wrapped about the entire periphery of the stack. The leading edge of the membrane, first edge contacted with the stack, and the trailing edge of the stack, end of the membrane sheet applied, are may be bonded to one another to complete the seal. This may be performed by use of an adhesive, by melt bonding or a molding process. In melt bonding the surface of the membrane and/or the edge of the stack are exposed to conditions at which the surface of one or both becomes molten and then the membrane and the edge of the stack are contacted while the surfaces are molten. The membrane and edge of the stack bond as the surface freezes forming a bond capable of sealing the components together. The membrane may be taken from a continuous sheet of the membrane material and cut to the desired length. The width of the membrane may match the height of the stacks of monopolar and bipolar plates. The membrane has sufficient thickness to seal the edges of the stack of monopolar and bipolar sheets to isolate the cells. The membrane may also function as a protective case surrounding the edges of the stack. The membrane may have a thickness of about 1 mm or greater, about 1.6 mm or greater or about 2 mm or greater. The membrane may have a thickness of about 5 mm or less, 4 mm or less or about 2.5 mm or less. When the membrane is bonded to the edge of the stack, any adhesive which can withstand exposure to the electrolyte and the conditions of operation of the cell may be used. Exemplary adhesives are plastic cements, epoxies, cyanoacrylate glues or acrylate resins. Alternatively, the membrane may be formed by molding a thermoplastic or thermoset material about a portion of, or all of, the stack of electrode plates. Any known molding method may be used including thermoforming, reaction injection molding, injection molding, roto molding, blow molding, compression molding and the like. The membrane may be formed by injection molding the membrane about a portion of or all of the stack of electrode plates. Where the membrane is formed about a portion of the stack of the plates it may be formed about the edges of the electrode plates or electrode plates and the separator.

The sealed stack may be placed in a case (e.g., outer seal) to protect the formed battery. The case may be the membrane or separate from a membrane. Alternatively, the membrane about the periphery of the electrode plate stack in conjunction with a protective covering over the monopolar plates at the end of the stack may be used as a case for the battery. As another alternative or in conjunction with, one or more frames of one or more electrode plates and/or separators bonded (e.g., melt-bonded) together about a peripheral surface may form the case. The monopolar plates may have an appropriate protective cover attached or bonded to the surface opposite the anode or cathode. The cover may be the same material as the membrane or a material that can be adhesively bonded or melt bonded to the membrane and can have a thickness within the range recited for the membranes. If affixed to the end of the plates the cover can be affixed with any mechanical attachment including the posts having overlapping portions. The case may be formed by molding a membrane about the stacks of electrode plates and/or the opposite sides of the monopolar plates.

The battery assembly may include one or more valves. The one or more valves may function to draw a vacuum from an interior of the battery assembly, fill the battery assembly with an electrolyte, fill or evacuate a fluid from one or more channels, and/or vent the battery assembly during operation. The one or more valves may include a pressure release valve, check valve, fill valve, pop valve, and the like, or any combination thereof. The one or more valves may be connected to and/or in communication with one or more channels. The one or more channels may be formed by one or more openings of an end plate, electrode plate, separator, or any combination thereof. The one or more channels may be one or more filling, venting, heating, and/or cooling channels. The one or more channels may be formed by one or more inserts having or free of one or more vent holes. The one or more valves may be in communication with one or more channels having a tubular member there through or free of a tubular member. The assembly may contain pressure release valves for one or more of the cells to release pressure if the cell reaches a dangerous internal pressure. The pressure release valves are designed to prevent catastrophic failure in a manner which damages the system the battery is used with. Once a pressure release valve is released the battery is no longer functional. The assemblies disclosed may contain a single check valve which releases pressure from the entire assembly when or before a dangerous pressure is reached. The battery assembly may include one or more valves as described in US 2014/0349147, incorporated herein by reference.

The battery assembly may include one or more terminals. The one or more terminals may function to transmit the electrons generated in the electrochemical cells to a system that utilizes the generated electrons in the form of electricity. The one or more terminals may pass through one or more end plates, one or more electrode plates, a membrane, and/or a case. The one or more terminals may pass through an electrode plate from an end plate to the outside or passing through the side of the case or membrane about the assembly essentially parallel to the plane of the end plates. The terminal matches the polarity of the anode or cathode of the monopolar plate. The cathode of the monopolar plate and the cathodes of one or more of the bipolar plates with a cathode current collector may be connected to independent positive terminals. The anode of the monopolar plate and the anodes of one or more of the bipolar plates with an anode current collector may be connected to independent negative terminals. The cathode current collectors may be connected, and the anode current collectors may be connected in parallel. The individual terminals may be covered in a membrane leaving only a single connected positive and a single connected negative terminal exposed. The assembly may contain one or more pairs of conductive terminals, each pair connected to a positive and negative terminal. The terminals are adapted to connect each battery stack to a load, in essence a system that utilizes the electricity generated in the cell. The terminals may be in contact with one or more conductive conduits in the assemblies.

The battery assembly may be attached to a load such that a circuit is formed which includes the electrochemical cells. Electrons are flowed to the terminals and to the load, which is a system using the electricity. This flow is maintained as long as the cells can generate electricity. If the electrode plate stack becomes fully discharged the battery needs to undergo a charging step before additional use. If the substrate for the electrode plates contains an electrically conductive material admixture at an operating temperature of the battery assembly that is below its phase transformation temperature, the substrate has an electrically conductive path via the material admixture, between a first surface and an opposing second surface of the substrate. At a temperature that is above the phase transformation temperature of the conductive material admixture, the electrically conductive material admixture undergoes a phase transformation that disables electrical conductivity via the electrically conductive path. This allows the disabling of the battery before untoward consequences occur. Once a battery is discharged it may be recharged by forming a circuit with a source of electrons. During charging the electrodes change function and the anodes during discharge become cathodes and the cathodes during discharge become anodes. In essence, the electrochemical cells flow electrons and ions in opposite directions as compared to discharge.

The battery assembly may be able to withstand internal pressures while or after drawing an internal vacuum, during operation (charging/discharging), or both, without deforming, warping, leaking, or cracking due to reinforcement from one or more end plates. Internal pressures while or after drawing an internal vacuum, before filling with an electrolyte, and/or before operating the battery assembly may be at or below atmospheric pressure, for example Earth's atmospheric pressure is about 14.7 psi (about 101.3 kPa). The battery assembly may be able to withstand internal pressures during operation without leaking or warping due to the internal pressures, the internal pressures of about 5 psi (34.5 kPa) or greater, about 10 psi (68.9 kPa) or greater, about 20 psi (137.9 kPa) or greater, about 50 psi (344.7 kPa) or greater and about 100 psi (689.5 kPa) or less (gauge pressure). For example, the battery assembly may be able to withstand internal pressures of about 6 psi (41.4 kPa) to about 10 psi (68.9 kPa) during operation. The assemblies may provide an energy density of about 34-watt hours per kilogram or greater, about 40-watt hours per kilogram or greater, or even about 50-watt hours per kilogram or greater. The assemblies of the invention can generate any voltage desired, such as 6, 12, 24, 48, 96, or even 200 volts.

Method for Assembling and Cooling Bipolar Battery Assembly

The present disclosure further relates to a method of assembling and cooling a battery assembly according to the present teachings.

The method may include circulating one or more fluids through one or more channels. Circulating one or more fluids may function to remove heat, add heat, or both to the battery assembly. The one or more fluids may be circulated during pickling, formation, charging, discharging, or a combination thereof. Circulating one or more fluids may include recirculating fluid within one or more channels, passing fluid through one or more channels, or both. Circulating fluid may include flowing one or more fluids into one end of a channel and then through an opposing end of a channel Circulating fluid may include circulating fluid from a first end to an opposing second end, and then back to the first end of a channel One or more fluids may be circulated through one or more tubular members within one or more channels. The one or more fluids may be circulated via one or more flow mechanisms. The one or more fluids may have a temperature lower than an interior of the battery assembly if being used for cooling, higher than an interior of the battery assembly if being used for heating, or both. The one or more fluids prior to entering into (e.g., circulating through) the one or more channels may have a temperature differential with an interior of the battery assembly (e.g., an interior of an electrochemical cell) of about 10° C. or greater, about 25° C. or greater, or even about 50° or greater. The one or more fluids prior to entering into (e.g., circulating through) the one or more channels may have a temperature differential with an interior of the battery assembly of about 100° C. or less, about 80° C. or less, or even about 70° or less. The temperature of the interior of the battery assembly may be the temperature of the battery during pickling, formation, charging, and/or discharging; a temperature prior to or simultaneous with one or more fluids flowing through; or a combination thereof. The one or more fluids prior to entering into the one or more channels may have a temperature of about 0° C. or greater, about 1° C. or greater, about 3° C. or greater, or even about 5° C. or greater. The one or more fluids prior to entering into the one or more channels may have a temperature of about 30° C. or less, about 20° C. or less, about 15° C. or less, or even about 10° C. or less.

The method may include forming an electrode plate stack. Forming an electrode plate stack may include aligning and stacking a plurality of electrode plates to form one or more electrochemical cells therebetween. One or more separators may be located between each pair of electrode plates. The electrode plates and separators may be stacked in an alternating arrangement. One or more frames of one or more electrode plates may align and/or interlock with one or more frames of one or more adjacent electrode plates and/or separators. One or more inserts of one or more electrode plates may align and/or interlock with one more inserts of one or more other electrode plates and/or separators. One or more inserts may align and pass through one or more openings of one or more separators. Alignment and interlocking of a plurality of inserts may form one or more channels.

The method may include forming one or more seals within one or more channels. The one or more seals may be formed according to the teachings herein with respect to the one or more seals, tubular members, rods, posts, inserts, or a combination thereof. The one or more seals may be formed by creating and/or inserting one or more tubular members into an interior of one or more channels. One or more tubular members may be formed according to the teachings provided herein. For example, a plurality of inserts may be melt-bonded along their inward facing surfaces, forming a continuous tubular member along a length of the channel. As another example, a rod may be inserted into the one or more channels. One or more tubular members may be affixed to an interior surface of the one or more channels, such as the inward facing surface of one or more inserts.

The method may include inserting and/or affixing one or more heat exchangers to the one or more channels. One or more heat exchangers may allow for one or more channels to function as one or more cooling channels, remove heat from an interior of the battery assembly, or both. One or more heat exchangers may be inserted and/or affixed according to the teachings herein related to one or more heat exchangers, tubular members, rods, posts, fluids, and the like. Inserting one or more heat exchangers may include locating one or more fluids within one or more channels (e.g., cooling channels). Inserting one or more heat exchangers may include forming and/or inserting one or more seals, tubular members, rods, and/or posts within one or more channels. Affixing one or more heat exchangers may include affixing one or more heat exchangers at one or more ends of an electrode plate stack, in communication with one or more channels, or both. One or more ends may include one or more monopolar plates, end plates, or both.

The method may include filling a plurality of electrochemical cells with an electrolyte. The one or more cells may be filled with an electrolyte before, during, and/or after one or more seals are formed, one or more heat exchanges are inserted and/or affixed, or a combination thereof. The battery assembly may be filled with electrolyte such as disclosed in PCT Publication WO 2013/062623 and U.S. Pat. No. 10,141,598, incorporated herein by reference in their entirety.

### Illustrative Examples

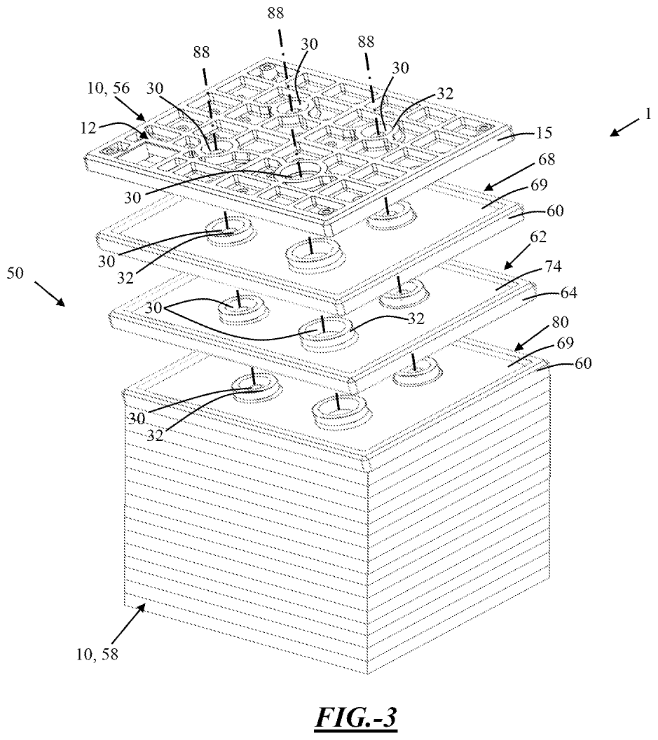

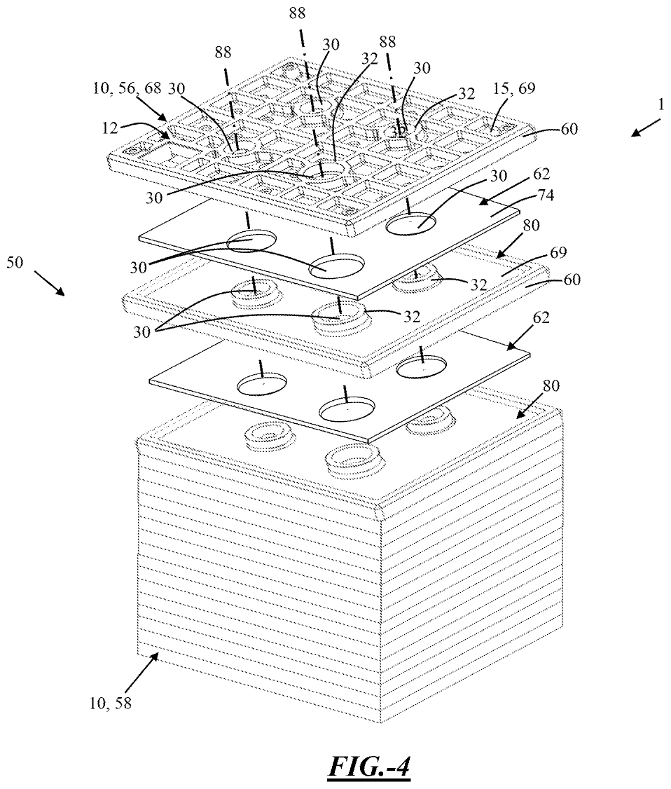

The following descriptions of the Figures are provided to illustrate the teachings herein but are not intended to limit the scope thereof. Features of any one example may be employed in another. For example, the separator in FIG. 4 may be used as the separator in FIGS. 2 and 3.

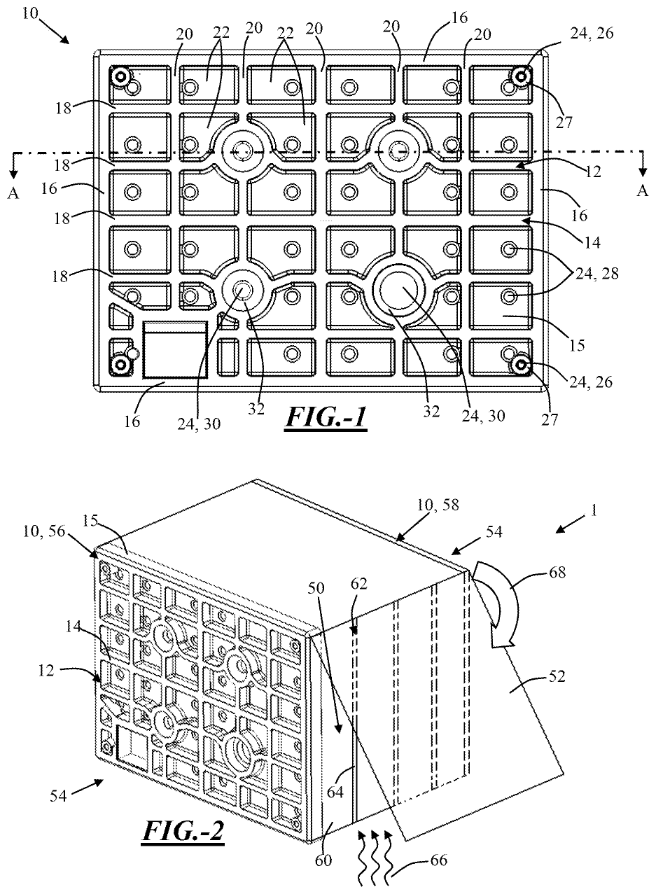

FIG. 1 illustrates an end plate 10. The end plate 10 includes an internal reinforcement structure 12. The internal reinforcement structure 12 includes a plurality of ribs 14 projecting from a base 15. The plurality of ribs 14 include an outer reinforcement rib 16 about the periphery of the end plate 10. The plurality of ribs 14 include a plurality of latitudinal ribs 18 and longitudinal ribs 20. The latitudinal ribs 18 are substantially perpendicular to the longitudinal ribs 20. The plurality of ribs 14 form a plurality of cells 22 which expose the base 15 between the ribs 14. The end plate 10 includes a plurality of openings 24. The plurality of openings 24 includes peripheral openings 26. The peripheral opening 26 may include a raised boss 27 about its periphery. The plurality of openings 24 further includes a plurality of internal openings 28. The internal openings 28 are disposed in the cells 22 formed between the plurality of ribs 14. The internal openings 28 extend through the base 15. The plurality of openings 24 includes a plurality of channel openings 30. Each channel opening 30 is partially surrounded by an insert 32 which projects from the base 15 of the end plate 10.

FIG. 2 shows applying a membrane 52 about an edge of a stack of electrode plates 50 as part of a battery assembly 1. Located at opposing ends 54 of the stack of electrode plates 50 are two of the end plates 10. The two end plates 10 include a first end plate 56 located at an opposing end 54 of the stack of electrode plates 50 as a second end plate 58. Each end plate 10 includes a base 15 from which a plurality of ribs 14 project to form an internal reinforcement structure 12. Disposed about the electrode plates 50 are frames 60. Sandwiched between the individual electrode plates 50 are separators 62. Disposed about each separator 62 are frames 64 for the separators. The frames 64 for the separators are between the frames 60 for the electrode plates 50. The membrane 52 is applied to the frames 60, 64 using a source of heat 66 and pressure 68 to seal the membrane 52 to the edge of the stack of electrode plates 50 and frames 60, 64.

FIG. 3 shows a partially exploded stack of electrode plates 50 which form a battery assembly 1. Shown is an end plate 10 which is a first end plate 56. The first end plate 56 includes an internal reinforcement structure 12. The end plate 10 includes a plurality of channel openings 30. Each channel opening 30 is partially surrounded by an insert 32 projecting from the base 15 of the end plate 10. Adjacent to the first end plate 10, 56 is a monopolar plate 68. The monopolar plate 68 includes a substrate 69 and a frame 60. The frame 60 forms a raised edge about the periphery of the substrate 69. The monopolar plate 68 includes a plurality of channel openings 30 in the substrate 69. Each channel opening 30 is partially surrounded by an insert 32 projecting from the substrate 69 of the monopolar plate 68. Adjacent to the monopolar plate 68 is a separator 62. The separator 62 includes a frame 64. The frame 64 forms a raised edge about the periphery of the separator 62. The separator 62 further includes a sheet 74, such as in the form of a glass mat, located in the interior and adjacent to the frame 64. The separator further includes a plurality of channel openings 30. Each channel opening 30 is partially surrounded by an insert 32 projecting from the separator 64. Adjacent to the separator 62 is a bipolar plate 80. The bipolar plate 80 includes a substrate 69 and a frame 60. The frame 60 forms a raised edge about the periphery of the substrate 60 of the bipolar plate 80. The bipolar plate 80 includes a plurality of channel openings 30. Each channel opening 30 is partially surrounded by an insert 32 projecting from the substrate 60 of the bipolar plate 80. The inserts 32 and channel openings 30 align and interlock to form one or more channels 88 passing transversely through the stack of electrode plates 50 and opposing end plates 56, 58. One or more of the channels 88 can receive one or more posts 96 (not shown) as disclosed in US Patent Publication 2014/0349147, incorporated herein by reference, such that one or more posts 96 (not shown) extend through one or more of the channels 88.

FIG. 4 shows a partially exploded stack of electrode plates 50 which form a battery assembly 1. Shown is an end plate 10 which is a first end plate 56. The end plate 10 is also a monopolar plate 68. The monopolar plate 68 includes an internal reinforcement structure 12. The monopolar plate 68 includes a plurality of channel openings 30. Each channel opening 30 is partially surrounded by an insert 32 projecting from the base 15. The base 15 is also the substrate 69 of the monopolar plate 68. Located about the substrate 69 is a frame 60. Adjacent to the monopolar plate 68 is a separator 62. The separator 62 is in the form of a sheet 74. The separator 62 further includes a plurality of channel openings 30. The channels openings 30 of the separator 62 allow for the inserts 32 of the electrode plates 50 to pass therethrough. Adjacent to the separator 62 is a bipolar plate 80. The bipolar plate 80 includes a substrate 69 and a frame 60. The frame 60 forms a raised edge about the periphery of the substrate 60 of the bipolar plate 80. The bipolar plate 80 includes a plurality of channel openings 30. Each channel opening 30 is partially surrounded by an insert 32 projecting from the substrate 69 of the bipolar plate 80. The inserts 32 and channel openings 30 align and interlock to form one or more channels 88 through the stack of electrode plates 50.

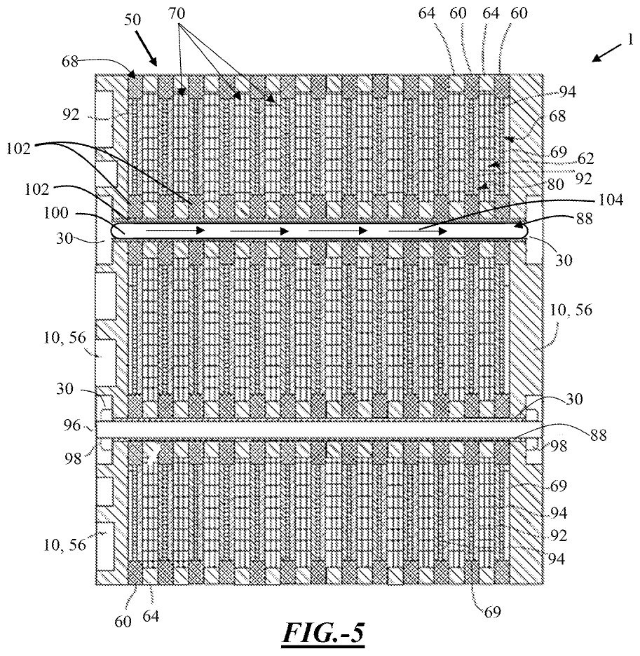

FIG. 5 shows a cutaway along the plane shown by line A-A of a battery assembly 1 through the channels 88 formed by the channel openings 30 which are aligned. The channels 88 pass through the stack of electrode plates 50. Shown is a monopolar plate 68 having a substrate 69 with a cathode 94 disposed thereon. The monopolar plate 68 includes a frame 60 about the substrate 69. Adjacent to the cathode 94 of the monopolar plate 68 is a separator 62. The separator includes a frame 64 about its periphery. Adjacent to separator 62 is a bipolar plate 80. The bipolar plate 80 includes a substrate 69 with an anode 92 and cathode 94 disposed thereon. The bipolar plate 80 includes a frame 60 about the periphery of the substrate 69. In this view, there are number of bipolar plates 80 alternatingly stacked with separators 62. At the opposite end of the stack is another monopolar plate 68 having a substrate 69 with an anode 92 disposed thereon. The stack of electrode plates 50 forms electrochemical cells 70 with the separators 62 located in the cells 70. The channels 88 pass transversely through the electrochemical cells 70. A post 96 is disposed within a channel 88. The post 96 includes an overlapping portion 98 formed at each end which seals the channel 88. Other posts 96 may be located within other transverse channels 88. A rod 100 is disposed within one of the channels 88. A fluid 104 may circulate through the rod 100. Located along the length of the channel 88 is a seal 102. The seal 102 can be formed by the one or more inserts of the one or more openings aligned to form the channel 88, such as by interlocking, being melt-bonded, or both. The seal 102 can also be formed as a separate sleeve disposed within the channel 88.

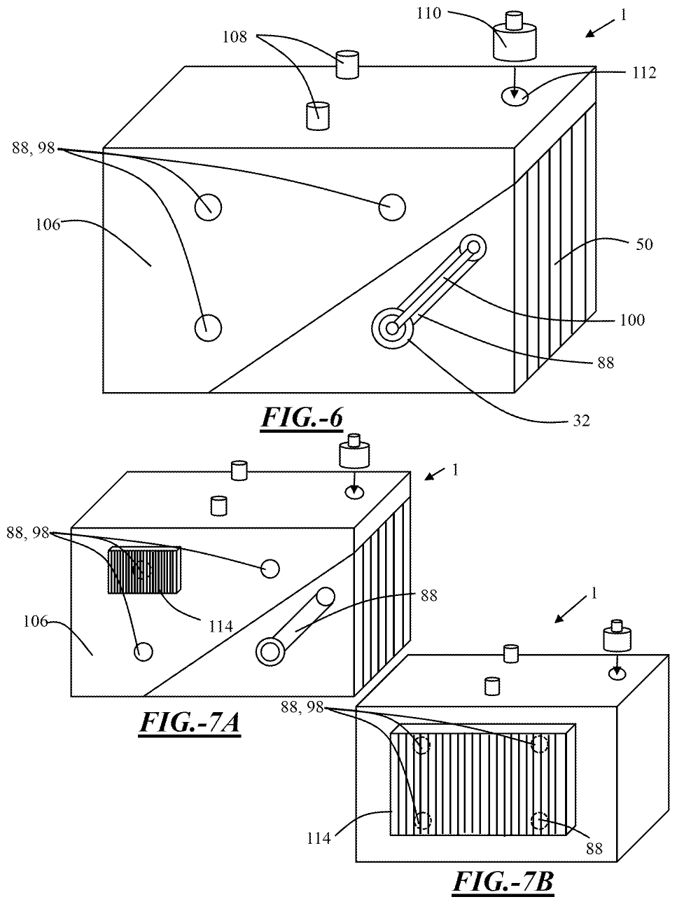

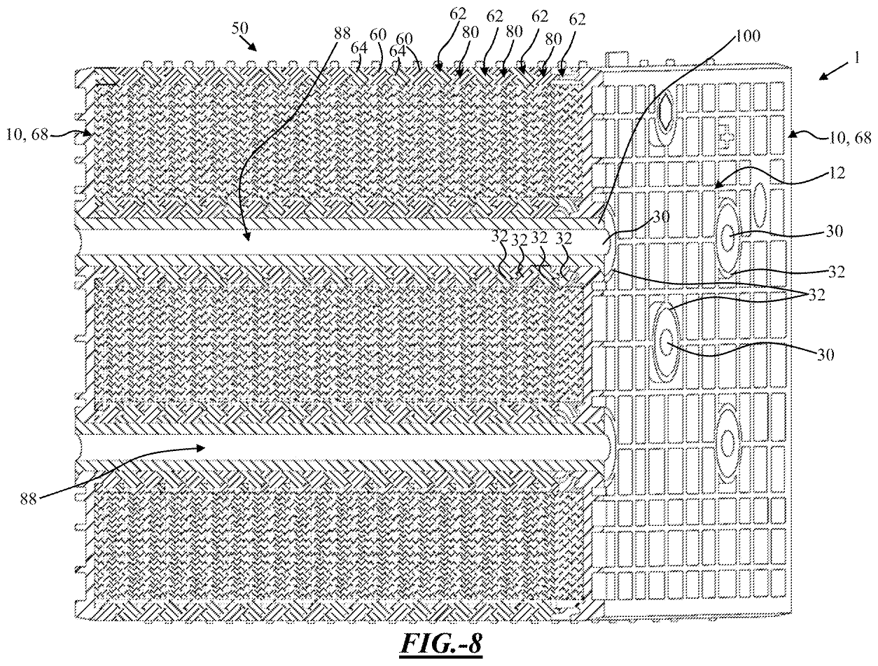

FIGS. 6 and 7 shows a partially cutaway view of a battery assembly 1. The battery assembly 1 includes a stack of electrode plates 50. Located about the stack of electrode plates 50 is an outer seal 106. The outer seal 106 is shown as partially cutaway or transparent. The battery assembly 1 includes a pair of conductive terminals 108. The battery assembly 1 includes a vent hole 112 in communication with a check valve 110. The battery assembly 1 includes a plurality of channels 88. Three of the channels 88 are shown as sealed. For example, the seal may be created by an overlapping portion 98 of a post 96. One of the channels 88 is shown as open. FIG. 5 shows that a rod 100 is located within the channel 88. FIG. 6 shows that the channel 88 is hollow, thus forming an integrated tube. The channel 88 may remain open or may be sealed. Located about the opening is an insert 32. FIG. 7 shows that the battery assembly 1 includes a heat sink 114. The heat sink 114 is in communication with one or more channels 88. The heat sink 114 may be in communication with one or more rods 100 (such as the rod 100 shown in FIG. 6) or other tubes located within one or more channels 88. An individual heat sink 114 may be in communication with a single channel 88, such as shown in FIG. 7A or an individual heat sink 114 may be in communication with a plurality of channels 88, such as shown in FIG. 7B. A heat sink 114 may be included as part of an end plate 10 (not shown).

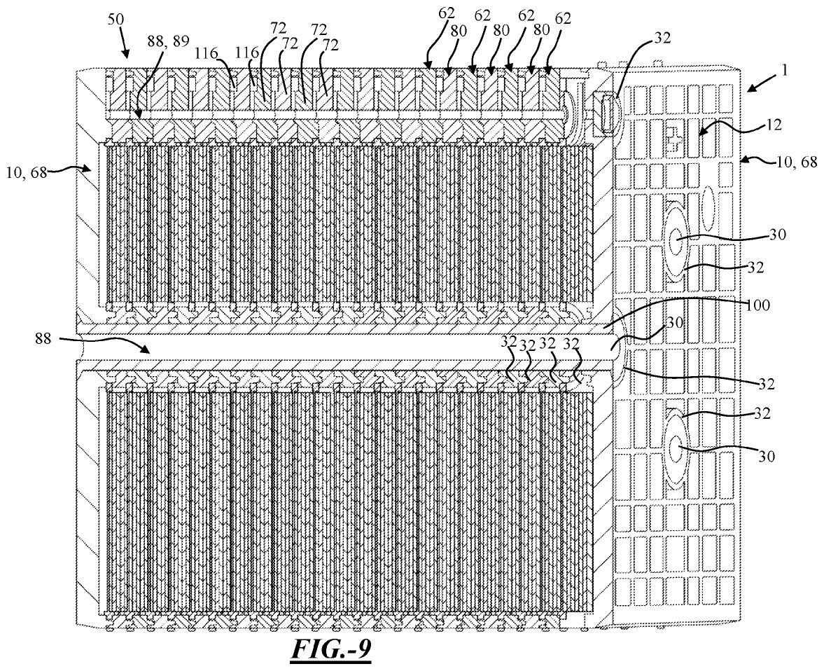

FIGS. 8 and 9 illustrate a perspective view of a cross-section of a battery assembly 1. The cross-section is taken through a plurality of channels 88. The battery assembly 1 includes an end plate 10. The end plate 10 is also a monopolar plate 68. The monopolar plate 68 includes an internal reinforcement structure 12. The battery assembly 1 includes a stack of battery plates 50. The battery plates 50 include the opposing monopolar plates 68 located at each end of the battery assembly 1 and alternating bipolar plates 80 and separators 62. The battery plates 50 and separators 62 includes inserts 32. The inserts 32 are aligned and interlock with one another. The inserts 32 include openings 30 therethrough. The openings 30 are aligned to form a channel 88. The channel(s) 88 extend transversely through the battery assembly 1. The channel(s) 88 include a rod 100 located therein. The rod 100 is hollow with open ends. The battery plates 50 and separators 62 include respective frames 60, 64. The frames 60, 64 are aligned and interlock with one another about the periphery of the battery assembly 1. FIG. 9 further illustrates some of the inserts 32 including vent holes 116. A channel 88 formed by inserts 32 having vent holes 116 is a vent and fill channel 89.

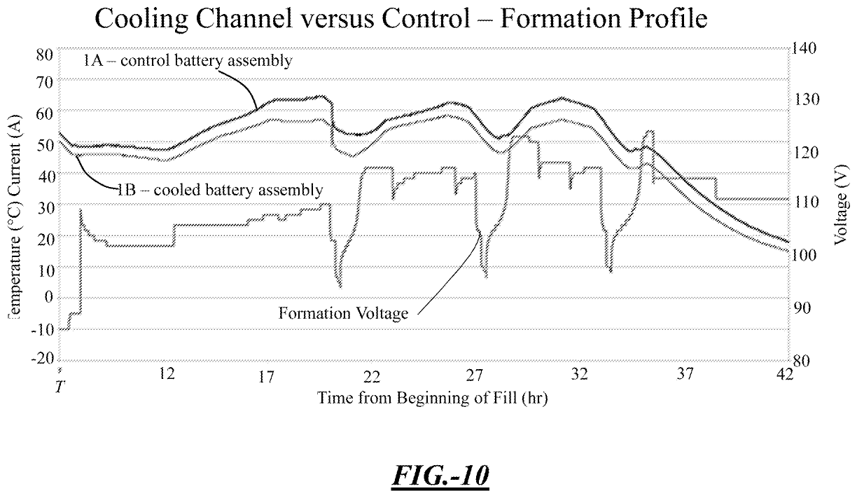

FIG. 10 illustrates a graph comparing the internal temperatures of a control battery assembly 1A and a cooled battery assembly 1B with a cooling channel. The control 1A does not have any channels 88 (not shown) which are utilized as cooling channels. The cooled battery assembly 1B includes a channel 88 (such as shown in FIG. 9) formed therein which is utilized as a cooling channel. The cooling channel is formed by having a channel which passes transversely through the battery assembly 1 and remains open at both ends. The internal temperatures of the control battery assembly 1A and the cooled battery assembly 1B are monitored during the formation process. During the formation process, both battery assemblies were submerged to 80% of their height in flowing water. Height is measured as the distance from one side of the battery to another side, perpendicular to the channel. The flowing water had a temperature of 5° C. The flowing water flowed transverse to the battery assembly, which is also parallel with (e.g., inline with) the cooling channel of the cooled battery assembly 1B. The water flowed around both battery assemblies 1A and 1B and through the cooling channel of the cooled battery assembly 1B. During this process, the control battery assembly 1A reached a maximum temperature of 65° C. while the cooled battery assembly 1B reached a maximum temperature of 58° C. Throughout formation over a period of about 42 hours, the average differential between the control battery assembly 1A and the cooled battery assembly 1B was about 6° C. with a maximum differential of about 10° C.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

What is claimed is:

1. A bipolar battery assembly comprising:
a) a plurality of electrode plates stacked together to form an electrode plate stack;
b) a liquid electrolyte located between each pair of the electrode plates; and
c) one or more channels passing transversely through the plurality of electrode plates and the liquid electrolyte; and
wherein the one or more channels include one or more cooling channels having one or more seals therein to seal the one or more channels from the liquid electrolyte;
wherein the one or more cooling channels are configured to have one or more fluids circulated therethrough to remove heat from an interior of the bipolar battery assembly during pickling, formation, charging, discharging, or a combination thereof.

2. (canceled)

3. The bipolar battery assembly of claim 1, wherein the one or more cooling channels include, are in communication with, or both one or more heat exchangers.

4-5. (canceled)

6. The bipolar battery assembly of claim 1, wherein the one or more channels are formed by one or openings in each individual electrode plate of the plurality of electrode plates which are aligned with one another; and
wherein the bipolar battery assembly includes a plurality of separators with an individual separator located between each pair of electrode plates, and wherein the plurality of separators each include one or more openings which are aligned with one or more openings of the electrode plates which form the one or more channels.

7-8. (canceled)

9. The bipolar battery assembly of claim 1, wherein the one or more seals are molded along one or more internal surfaces of the one or more cooling channels to seal the one or more channels form the liquid electrolyte.

10. (canceled)

11. The bipolar battery assembly of claim 9, wherein the one or more seals are formed by one or more inward facing surfaces of one or more inserts aligned and interlocking to form the one or more channels, the one or more seals are separate from and located on the one or more inward facing surfaces of the one or more inserts, or both.

12. (canceled)

13. The bipolar battery assembly of claim 1, wherein the one or more seals run along an entire length of the one or more cooling channels in which they are located.

14. The bipolar battery assembly of claim 13, wherein the one or more seals include one or more tubular members which are located within the one or more cooling channels.

15. The bipolar battery assembly of claim 14, wherein one or more tubular members are molded in place within the one or more channels.

16-18. (canceled)

19. The bipolar battery assembly claim 1, wherein the one or more cooling channels include the one or more fluids circulating therethrough.

20. The bipolar battery assembly of claim 14, wherein the one or more tubular members are one or more rods located within the one or more cooling channels or the one or more tubular members have one or more rods located therein.

21-23. (canceled)

24. The bipolar battery assembly of claim 20, wherein the one or more rods have a thermo-conductivity of about 100 W/m·K or greater.

25. (canceled)

26. The bipolar battery assembly of claim 20, wherein the one or more rods comprise aluminum, copper, boron arsenide, diamond, graphene, carbon nanotubes, or a combination thereof.

27. The bipolar battery assembly of claim 20, wherein the one or more rods comprise one or more heat pipes with the one or more fluids sealed therein.

28. The bipolar battery assembly of claim 20, wherein the one or more rods include one or more open ends such that the one or more fluids are able to flow in and out of the one or more rods; or
wherein the one or more rods are sealed at both ends such that the one or more fluids are sealed therein.

29-30. (canceled)

31. The bipolar battery assembly of claim 14, wherein one or more tubing couplers are located on one or more ends of at least one of the one or more cooling channels, and
wherein the one or more tubing couplers attach the one or more tubular members to the one or more cooling channels.

32. (canceled)

33. A method of assembling and cooling the bipolar battery, the method comprising:
a) forming an electrode plate stack by stacking a plurality of electrode plates to create a plurality of electrochemical cells therebetween and one or more channels passing transversely through the plurality of electrode plates, wherein the one or more channels include one or more cooling channels;
b) filling the plurality of electrochemical cells with a liquid electrolyte, wherein the one or more channels pass transversely through the liquid electrolyte; and
c) circulating one or more fluids through the one or more cooling channels to remove heat from an interior of the bipolar battery assembly;
wherein the one ore more cooling channels include one or more seals therein to seal the one or more channels from the liquid electrolyte; and
wherein the one or more fluids are circulated through the one ore more cooling channels during pickling, formation, charging, discharging, or a combination thereof of the bipolar battery assembly.

34. The method of claim 33, wherein the one or more fluids are circulated via one or more flow mechanisms.

35. The method of claim 33, wherein the one or more fluids prior to being circulated through the one or more channels have a temperature differential with an interior of the battery assembly of about 25° C. or greater, and
wherein a temperature of the interior of the battery assembly is the temperature measured prior to or simultaneous with the one ore more fluids passing therethrough; and
wherein a temperature of the one or more fluids is the temperature measured prior to entering into the one or more cooling channels.

36. (canceled)

37. The method of claim 33, wherein the one or more fluids have a temperature of about 0° C.

38-39. (canceled)

40. The method of claim 33, wherein the method includes inserting and/or affixing one or more heat exchangers to the one or more channels.
